(19) United States
(12) Patent Application Publication
(10) Pub. No.: US 2016/0181622 A1
(43) Pub. Date: Jun. 23, 2016

(54) TEMPLATE DIRECTED FORMATION OF METAL NANOPARTICLES AND USES THEREOF

(71) Applicant: University of South Australia, Adelaide, South Australia (AU)

(72) Inventors: Naba K. Dutta, Mawson Lakes, South Australia (AU); Namita Roy Choudhury, Mawson Lakes, South Australia (AU); Sundar Mayavan, Karaikudi, Tamil Nadu (IN); Rajkamal Balu, Mawson Lakes, South Australia (AU); Jasmin Whittaker, Mawson Lakes, South Australia (AU); Christopher M. Elvin, St. Lucia, Queensland (AU); Anita J. Hill, Clayton, Victoria (AU)

(21) Appl. No.: 14/442,345

(22) PCT Filed: Nov. 12, 2013
(86) PCT No.: PCT/AU2013/001300

§ 371 Date: May 12, 2015

(30) Foreign Application Priority Data
Nov. 12, 2012 (AU) 2012904970

(51) Int. Cl. H01M 4/92; H01M 8/1004; B22F 1/00; H01M 8/16; B22F 9/18; B22F 1/02

(52) U.S. Cl. CPC H01M 4/925; B22F 9/18; B22F 1/02; B22F 1/0018; H01M 8/16; H01M 8/1004; B22F 2301/25; B22F 2301/00; B22F 2302/45; B22F 2304/05; B82Y 40/00

(57) ABSTRACT

Disclosed herein is a composition of matter comprising metal nanoparticles dispersed in a protein matrix comprising an elastic protein or homolog or fragment thereof. The metal may be an electrocatalyst metal. Also disclosed are electrodes, electrochemical half-cells and fuel cells comprising the composition of matter.

### PRIORITY DOCUMENT

The present application claims priority from Australian Provisional Patent Application No. 2012904970 titled “TEMPLATE DIRECTED FORMATION OF METAL NANOPARTICLES AND USES THEREOF” and filed on 12 Nov. 2012, the contents of which are hereby incorporated by reference in their entirety.

### TECHNICAL FIELD

The present invention relates to the formation of metal nanoparticles and their use as electrocatalysts.

### BACKGROUND

Fuel cells are widely regarded as future alternatives to fossil fuel based power sources for vehicles and portable electronic devices because of their high efficiency, low to zero emissions, low corrosion, simplified design and increased durability.

Fuel cells are typically either proton exchange membrane (PEM of PEMFC) fuel cells fuelled by hydrogen gas or direct methanol fuel cells (DMFC) fuelled by methanol. To date, a limiting factor in the commercialisation of PEMFCs and DMFCs has been the platinum catalysts used in the cells to oxidise hydrogen gas or methanol and reduce oxygen gas. For example, sluggish oxygen reduction reaction (ORR) kinetics, carbon monoxide (CO) poisoning, degradation of activity over electrochemical cycling have all been recognised as problems with existing catalysts. The practical application of PEMFCs and DMFCs will only be realised if the effectiveness, utilisation efficiency, stability and cost of platinum-based catalysts can be improved.

To date, considerable research has been carried out in order to improve the ORR kinetics of PEMFCs and DMFCs. Platinum black has been used as a catalyst but it has a low surface area and, therefore, large loadings of platinum are required for reasonable performance. Platinum or platinum alloy catalysts supported on high surface area carbon black (Pt/C) have subsequently been developed and are currently the only feasible electrocatalyst for PEMFC systems. To address this problem, supported transition metal alloys, including platinum/iron (Pt/Fe), platinum/manganese (Pt/Mn), platinum/nickel (Pt/Ni), platinum/titanium (Pt/Ti), platinum/chromium (Pt/Cr), platinum/copper (Pt/Cu) and platinum/ruthenium (Pt/Ru) have been investigated. However, the complexity and importance of not only alloy composition but also the size, shape, morphology, and surface structures has led to recent focus on model catalytic systems, including clean metal single crystals and lithographically fabricated metal nanostructures.

Using a model catalyst in simulated test conditions Zhang et al. demonstrated that Pt-oxygen-reduction fuel cell electrocatalysts can be stabilized against dissolution by modifying Pt nanoparticles with gold (Au) clusters (Zhang et al. 2007). Stamenkovic et al. reported that a cathode all-platinum electrode captures hydroxide (OH) tightly; restricting access of oxygen (O₂) to the catalyst site and alloying Pt with nickel can accelerate the desired oxygen-splitting reaction. Alayoglu et al. attempted to develop a new nanoparticle catalyst comprising of a Ru core covered with a shell of Pt atoms (Ru@Pt core-shell nanoparticle), which is markedly different from nanoparticles of ‘bulk’ Pt/Ru alloys or monometallic Pt and Ru mixtures of identical loadings and compositions (Alayoglu et al. 2008). These recent researches with model bimetallic catalytic systems have provided some mechanistic insight of the atomic surface chemistry governing their catalytic activity (Joo et al. 2009). Remarkable catalytic activity of supported nanoparticles have also been reported when their diameters fall below ˜2 nm (Heiz et al. 1991; Meusel et al. 2001). Pt nanoparticles with various shapes such as cube, octahedron, nano-rod and various multipod, porous flower-like, irregular polyhedron, multibranched rod, nanodendrites, and caterpillar-like structures have also been synthesised but the challenge remains to synthesize them with high levels of control over the uniformity in size, shape and composition and also keep them accessible to reactants.

At present in PEMFCs, the functional role of the carbon support is to provide electrical connection between the widely dispersed Pt catalyst particles and the porous current collector. However, the significant oxidation of the carbon support and its poor long-term durability are also considered to be one of the most critical issues for wider application of PEMFCs. Moreover, the lack of robust electrical connection between the catalyst and the support and the impermeability of the carbon support to reactant gases and its lack of proton conductance, reactants (oxygen/hydrogen), water and proton transport limit the efficiency of the electrocatalyst that can be achieved. To address this issue CNTs have been proposed as catalyst support materials due to their unique structural, electrical and mechanical properties and a wide electrochemical stability window and very high surface area (Prabhuram et al. 2006). For catalytic applications, metal nanoparticles exhibit dramatic size dependent activity and remarkable catalytic activities of supported monometallic nanoparticles have recently been reported when their diameters fall below ˜3.5 nm.

However, there is a major gap in the model catalyst design and development, and the practical synthesis of heterogeneous catalyst nanoparticles in relation to engineering the composition, size, shape, structure, morphology, surface characteristics and/or geometry. Amongst various methods, colloidal synthetic methods employing supramolecular systems as the template/directing agent have proven beneficial in designing nano-scale systems. Nanoparticles with a well-developed shape and a narrow size distribution reported thus far have been generally in the size range of 100 nm or more. The major challenge remains in the synthesis and controlling the structure of metals at the mesoscale (2 to 50 nm), which is crucial for the development of improved fuel cell electrodes and other optical and electronic applications.

### SUMMARY

In a first aspect, the present invention provides a composition of matter comprising metal nanoparticles dispersed in a protein matrix comprising an elastic protein or homolog or fragment thereof. The metal nanoparticles dispersed in a protein matrix can be prepared by reducing ions of the metal in the presence of the elastic protein or homolog or fragment thereof to provide zero-valent metal nanoparticles dispersed in the protein matrix.

The metal may be a noble metal. The noble metal may be selected from the group consisting of platinum, gold, silver, iridium, palladium, osmium, rhodium, ruthenium, and alloys of any one or more of the aforementioned metals.

Alternatively, or in addition, the metal may be an electrocatalyst metal. The electrocatalyst metal may be selected from the group consisting of: platinum, palladium, gold, silver, manganese, iron, magnesium, and alloys of any one or more of the aforementioned metals. Thus, in a second aspect, the present invention provides a composition of matter comprising electrocatalyst metal nanoparticles dispersed in a protein matrix comprising an elastic protein or homolog or fragment thereof.

In a third aspect, the present invention provides an electrocatalyst comprising catalytic metal nanoparticles dispersed in a protein matrix an elastic protein or homolog or fragment thereof.

In a fourth aspect, the present invention provides an electrode comprising an electrically conductive support and catalytic metal nanoparticles dispersed in a protein matrix comprising an elastic protein or homolog or fragment thereof on the support.

In a fifth aspect, the present invention provides an electrochemical half-cell comprising an electrode and a housing for maintaining an electrolyte in contact with the electrode, the electrode comprising an electrically conductive support and catalytic metal nanoparticles dispersed in a protein matrix comprising an elastic protein or homolog or fragment thereof on the support.

In a sixth aspect, the present invention provides a fuel cell comprising an electrolyte membrane and an anode and a cathode sandwiching the electrolyte membrane, at least one of the cathode and anode comprising an electrically conductive support and catalytic metal nanoparticles dispersed in a protein matrix comprising an elastic protein or homolog or fragment thereof on the support.

In a seventh aspect, the present invention provides a method of preparing nanoparticles of a metal, the method comprising reducing ions of the metal in the presence of a protein comprising an elastic protein or homolog or fragment thereof to provide zerovalent metal nanoparticles dispersed in a protein matrix comprising the elastic protein or homolog or fragment thereof.

The method of the present invention provides a simple, robust, efficient method for forming nanoparticles.

In embodiments of the seventh aspect, the method comprises providing a solution or suspension containing ions of the metal and the protein comprising an elastic protein or homolog or fragment thereof; contacting the solution with a reducing agent under conditions to reduce the ions of the metal to zerovalent noble metal to provide a reduced solution comprising metal nanoparticles dispersed in the protein matrix comprising an elastic protein or homolog or fragment thereof.

In embodiments of the seventh aspect the metal is a noble metal.

In further embodiments of the seventh aspect in which the metal is an electrocatalyst metal, the method further comprises contacting the reduced solution with an electrically conductive support material under conditions to deposit at least some of the metal nanoparticles dispersed in the protein matrix comprising an elastic protein or homolog or fragment thereof on the surface of the support.

In embodiments, the electrocatalyst metal is platinum metal and/or a platinum alloy. In embodiments, the platinum alloy is selected from the group consisting of: Pt/Ru, Pt/Co, Pt/Fe, Pt/Ni, Pt/Mn, Pt/Ti, Pt/Cr, Pt/Cu, Pt/Pd, Pt/Rh, Pt/Ir, Pt/Ag, and Pt/Au.

In other embodiments, the electrocatalyst metal is palladium metal and/or a palladium alloy. In embodiments, the palladium alloy is selected from the group consisting of: Pd/Co, Pd/Ni, Pd/Au, Pd/Ru, Pd/Ir, Pd/Mn, Pd/Ti, Pd/Cr, Pd/Cu, Pd/Ag, and Pd/Rh.

In still other embodiments, the electrocatalyst metal is selected from the group consisting of: gold, silver, manganese, iron, magnesium, and alloys of any one or more of the aforementioned metals.

In embodiments, the protein comprising an elastic protein or homolog or fragment thereof comprises at least a portion of the amino acid sequence of a protein or polypeptide from the resilin group of proteins. The protein may be a natural or synthetic protein or polypeptide. The resilin family protein or homolog thereof may be recombinant resilin, such as rec1-resilin or An16. In embodiments, the resilin family protein or homolog thereof comprises an amino acid sequence consisting of a portion of the amino acid sequence set forth in either FIG. 1 (SEQ ID NO:1) or FIG. 15 (SEQ ID NO: 2).

In other embodiments, the protein comprising an elastic protein or homolog or fragment thereof comprises at least a portion of the amino acid sequence of a silk fibroin protein or polypeptide. The silk fibroin may be a natural or synthetic protein or polypeptide.

In embodiments of the fourth to seventh aspects, the electrically conductive support is a high surface area carbon, alumina or silica material. In specific embodiments, the support comprises fullerenes, graphene, carbon nanotubes, carbon nanobuds, and/or carbon nanofibres. Suitable carbon nanotubes include single wall carbon nanotubes and multiwalled carbon nanotubes (MWCNTs). The electrically conductive support can be used directly as an electrocatalyst and the catalyst surface is accessible to reactants.

### BRIEF DESCRIPTION OF THE ACCOMPANYING FIGURES

Illustrative embodiments of the present invention will be discussed with reference to the accompanying drawings wherein:

FIG. 1 shows the structural consensus and alignment of amino acid repeat sequence in rec1-resilin (SEQ ID NO: 1). One-letter code is used to present the protein sequence.

FIG. 2 shows microphotographs showing that the periodic distance between particles varies with change in molar ratio Pt to rec1-resilin in solution as shown in: (a) (0.024 mM); (b) (0.24 mM); (c) (1.2 mM); and (d) (2.4 mM). The particles lead to the formation of a one dimensional chain like structures at high Pt concentration.

FIG. 3(a) is a schematic diagram showing how the functionalized MWCNT is used as a substrate for depositing biosynthesized platinum NPs using precursor concept; (b) is a transmission electron micrograph showing the adsorption and assembly of Pt (3-5 nm) onto the walls of MWCNT at room temperature; (c) shows a cyclic voltammogram of a Pt heterostructure in 0.5 M H₂SO₄+0.5 M CH₃OH; and (d) shows cyclic voltammograms of a Pt heterostructure under a scanrate of 50 mV/s before and after accelerated durability test (1000 cycle) (E/V vs SCE).

FIG. 4 is plot showing the relative loss in electrochemical surface area during 1000 potential cycles within 0-1.0 V/RHE with a scan rate of 50 mV/s.

FIG. 5 shows UV-vis absorption spectra of pure rec1-resilin at various H₂PtCl₆ concentrations.

FIG. 6(a) shows DLS spectra of 3.5 μM aqueous solution of rec1-resilin over a broad range of pH (from 2.8 to 10.8); (b-d) shows TEM microphotographs showing the size distribution of Pt NP at: (b) pH 7.4, scale bar 10 nm; (c) pH 11.7; scale bar 20 nm; and (d) pH 2.8; scale bar 0.5 μm.

FIG. 7 shows TEM images of the Pt-M decorated MWCNT; (a) Pt—Co; (b) Pt—Au; (c) Pt and Pt—Ru.

FIG. 8 shows XPS of Pt (4f) core level region of (a) Pt, (b) Pt—Au, (c) Pt—Ru and Pt—Co supported on MWCNT electrocatalysts.

FIG. 9 shows cyclic voltammograms of PtAu (A), PtCo (B) and PtRu (C) samples in 0.5 M H₂SO₄ and in 0.5 M methanol/0.5 M H₂SO₄ at a scan rate of 50 mV s−1 for hydrogen oxidation reaction (HOR) and methanol oxidation reaction (MOR), respectively.

FIG. 10 shows cyclic voltammograms of PtAu (A), PtCo (B) and PtRu (C) samples in O.5 M H₂SO₄ and in O.5 M methanol/0.5 M H₂SO₄ at a scan rate of 50 mV s⁻¹, after potential cycling for hydrogen oxidation reaction (HOR) and methanol oxidation reaction (MOR), respectively.

FIG. 11 shows polarization curves for (A) Pt, (B) PtAu, (C) PtCo and (D) PtRu in 0.5 M H₂SO₄ saturated with pure oxygen.

FIG. 12 shows polarization curves of Pt and its alloys in 0.5 M H₂SO₄ solution saturated with O₂ (high over potential regime) at 2000 rpm.

FIG. 13 shows photographs of rec1-resilin stabilized aqueous colloidal sols containing different molar concentration of silver nanoparticles. The colour of the solution became progressively darker with increasing silver particle concentration.

FIG. 14 shows UV-vis absorption spectra of a cross section of rec1-resilin stabilized aqueous colloidal sols containing different concentration of silver nanoparticles, AgNP. The appearance of the surface plasmon resonance (SPR) band with distinct maxima for the sols with various AgNPs is clearly visible.

FIG. 15 shows the structural consensus and alignment of the amino acid repeat sequence in An16-resilin (SEQ ID NO: 2). One-letter code is used to present the protein sequence.

FIG. 16 shows photographs of An16-stabilized aqueous colloidal sols containing different molar concentration of gold nanoparticles. The colour of the solution progressively becomes darker with increasing gold particle concentration.

FIG. 17 shows UV-vis absorption spectra of a cross section of An16 stabilized aqueous colloidal sols containing different concentration of gold nanoparticles, AuNP. The appearance of the surface plasmon resonance (SPR) band with distinct maxima at wavelength of ˜520 nm for the sols with various AuNPs is clearly visible.

FIG. 18 shows photographs of An16-stabilized aqueous colloidal sols containing different molar concentration of silver nanoparticles. The colour of the solution progressively becomes darker with increasing silver particle concentration.

FIG. 19 shows UV-vis absorption spectra of a cross section of An16-stabilized aqueous colloidal sols containing different concentration of silver nanoparticles, AgNPs. The appearance of the surface plasmon resonance (SPR) band with distinct maxima at ˜403-423 nm wave length for the sols with various AgNPs is clearly visible.

FIG. 20 shows photographs of silk fibroin-stabilized aqueous colloidal sols containing different molar concentration of gold nanoparticles. The colour of the solution progressively becomes darker with increasing gold particle concentration.

FIG. 21 shows UV-vis absorption spectra of a cross section of silk stabilized aqueous colloidal sols containing different concentrations of gold nanoparticles, AuNPs. The appearance of the surface plasmon resonance (SPR) band with distinct maxima at wavelength of ˜500-540 nm for the sols with various AuNPs is clearly visible.

FIG. 22 shows photographs of silk fibroin-stabilized aqueous colloidal sols containing different molar concentration of silver nanoparticles. The colour of the solution progressively become darker with increasing silver particle concentration

FIG. 23 shows. UV-vis absorption spectra of a cross section of silk stabilized aqueous colloidal sols containing different concentration of silver nanoparticles, AgNP. The appearance of the surface plasmon resonance (SPR) band with distinct maxima at 410 nm to 414 nm wavelength for the sols with various AgNPs is clearly visible.

### DETAILED DESCRIPTION

The present invention provides a composition of matter comprising metal nanoparticles dispersed in a protein matrix comprising an elastic protein or homolog or fragment thereof. The metal nanoparticles dispersed in a protein matrix can be prepared by reducing ions of the metal in the presence of the elastic protein or homolog or fragment thereof to provide zero-valent metal nanoparticles dispersed in the protein matrix.

As used herein, the term “nanoparticles” means a particle having an average diameter of from 1 to 100 nanometer.

As used herein, the term “elastic protein” means any naturally occurring or engineered protein, peptide, or polypeptide that has resilience properties, such as resilin, silk proteins, elastin, titin, fibrillin, lamprin gliadin, abductin, byssus, spectrin, and homologs or fragments of any of the aforementioned. Preferably, the elastic protein comprises repeating units comprising tyrosine, serine and/or threonine-containing amino acid residues. Recent developments in genetic engineering have made possible the replication of partial genomes of various organisms to synthetically produce elastic proteins. The comparative structures and properties of elastic proteins have been reviewed by Tatham and Shewry (Tatham and Shewry 2002) and the contents of that review are hereby incorporated by reference.

In embodiments, the metal is a noble metal. The noble metal may be selected from the group consisting of: platinum; gold, silver, iridium, palladium, osmium, rhodium, ruthenium and alloys of any one or more of the aforementioned metals.

The metal may be an electrocatalyst metal. The composition may therefore be used as an electrocatalyst. Thus, the present invention provides a composition of matter comprising electrocatalyst metal nanoparticles dispersed in a protein matrix comprising an elastic protein or homolog or fragment thereof. The composition may be used as an electrocatalyst. The electrocatalyst metal nanoparticles dispersed in a protein matrix can be prepared by reducing ions of the electrocatalyst metal in the presence of the elastic protein or homolog or fragment thereof to provide zero-valent electrocatalyst metal nanoparticles dispersed in the protein matrix.

As used herein, the term “electrocatalyst” means any catalyst that participates in electrochemical reactions. The electrocatalyst assists in transferring electrons between the electrode and reactants.

The present invention is predicated, at least in part, on our finding that elastic proteins comprising repeating units comprising tyrosine, serine and/or threonine-containing amino acid residues are able to template and/or stabilize noble metal nanoparticles, such as platinum, gold and silver nanoparticles as they are forming. Without intending to be bound by any particular theory, we suggest that elastic proteins having hydrophilic binding sites that are accessible are able to bind electrocatalyst metal ions and that the binding sites within the protein provide distinct characteristics and kinetics that assist in controlling the size and assembly of metallic particles; a key factor in determining catalytic, electronic and optical response in nanoparticle based systems.

In embodiments, the elastic protein comprises a tyrosine, serine and/or threonine-containing amino acid sequence of a protein or polypeptide selected from the group consisting of: resilin, silk proteins, elastin, titin, fibrillin, lamprin, gliadin, abductin, byssus, spectrin, and homologues and fragments of any of the aforementioned.

In some embodiments, the elastic protein is a resilin family protein or homolog thereof. Resilin is a member of the family of natural elastic proteins. Native resilin occurs as a highly elastic extracellular skeletal component in insects and is purported to be the most resilient material known.

In embodiments, the protein comprising a resilin family protein or homolog thereof comprises at least a portion of the amino acid sequence of a protein or polypeptide from the resilin group of proteins. Resilin proteins are found naturally in many insects and any of the known natural resilin proteins may be used. Furthermore, the protein may be a homolog of a natural resilin protein. The homolog may have 50%, 55%, 60%, 65%, 70%, 75%, 80%, 85%, 90%, 91%, 92%, 93%, 94%, 95%, 96%, 97%, 98%, 99% or greater than 99% homology with a known resilin protein.

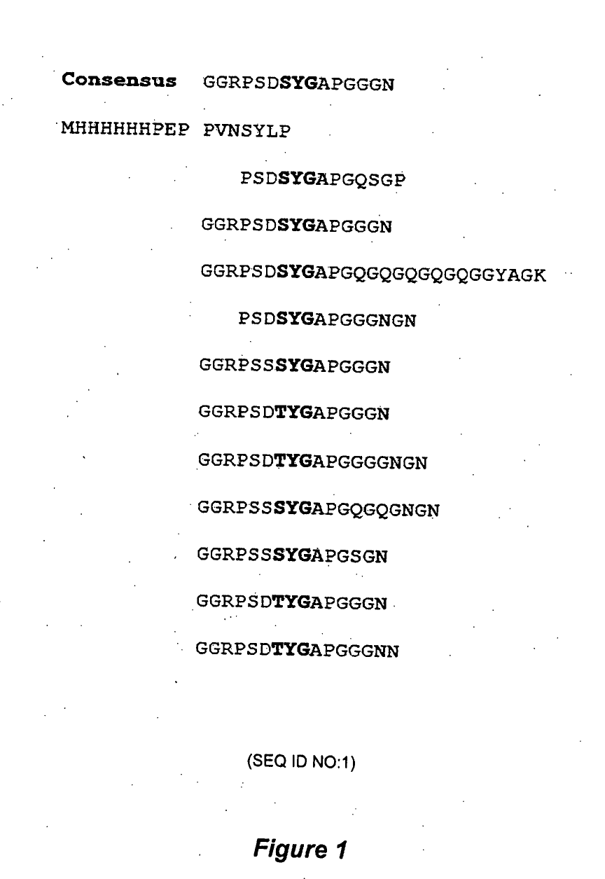

The resilin protein may be a recombinant resilin protein. A particularly useful recombinant resilin is the resilin-mimetic protein rec1-resilin which has previously been produced by recombinant DNA technology. Specifically, the exon-1 of the Drosophila melanogaster gene CG 15920 was cloned and expressed in Escherichia coli and was purified. The details of the procedure are described in the literature (Elvin et al., 2005). The soluble protein, rec1-resilin, thus prepared has concentration range from 200 to 300mg ml⁻¹. Structurally red-resilin consists of 310 amino acid residues, (molecular weight: 28.492 kD) containing repeat sequences of the resilin gene CG15920 (19-321 residues in the N-terminal region of a 620 amino acid sequence). The structural consensus and the amino acid compositions are given in FIG. 1 (SEQ ID NO:1). The protein may also be a homolog of the protein of SEQ ID NO:1. The homolog may have 50%, 55%, 60%, 65%, 70%, 75%, 80%, 85%, 90%, 91%, 92%, 93%, 94%, 95%, 96%, 97%, 98%, 99% or greater than 99% homology with the protein of SEQ ID NO:1.

Mother useful recombinant resilin protein is An16 which has been produced synthetically based on a resilin gene identified in Anopheles gambiae (African malaria mosquito). A synthetic construct based on the consensus repeat unit coded for by this gene was developed and the resulting protein (An16) was expressed and purified (Lyons et al., 2007). The protein may also be a homolog of the An16 protein. The homolog may have 50%, 55%, 60%, 65%, 70%, 75%, 80%, 85%, 90%, 91%, 92%, 93%, 94%, 95%, 96%, 97%, 98%, 99% or greater than 99% homology with the An16 protein.

In other embodiments, the elastic protein is a silk protein or homolog thereof. The silk protein may be a spider silk protein or a silk worm silk protein. The silk protein is preferably a silk fibroin derived from silk produced by domesticated silkworms (e.g. Bombyx mori) or wild silkworms (e.g. Antheraea pernyi, Antheraea yamamai, Antheraea militta, Antheraea assama, Philosamia cynthia ricini and Philosamia cynthia pryeri). Aqueous solutions of silk fibroins are disclosed in published United States patent application 20040005363 (T. Arai and M. Tsukada) the details of which are incorporated herein by reference. A suitable silk fibroin has also been prepared by Rockwood et al (2011) the details Of which are also incorporated herein by reference. The elastic protein may be a homolog of a silk fibroin. The homolog may have 50%, 55%, 60%, 65%, 70%, 75%, 80%, 85%, 90%, 91%, 92%, 93%, 94%, 95%, 96%, 97%, 98%, 99% or greater than 99% homology with the silk fibroin.

Preferably, the surface of the elastic protein is negatively charged such that it is able to bind ions of the electrocatalyst metal. For example, at pH>˜10.5 the hydroxyl group of tyrosine (Tyr) residues in resilin family proteins become deprotonated and the Tyr residues in “tyrosinate” form are highly hydrophilic and accessible (Dutta et al. 2011; Truong et al. 2010). The progressive unfolding of proteins with pH results in the exposure of novel binding sites for the metal ions. For example, at pH 7.4 monodisperse Pt particles of size 2-3 nm were formed. However, ultra-fine particles of size ranging from 0.75 -1.5 nm were observed at a pH 11.7. In contrast, a colloidal solution of resilin family protein at low pH (pH<pI; where pI is the isoelectric point) exhibits very little capability to stabilize Pt colloids. In the latter case, the steric stabilization does not appear to provide colloidal stability of the sols as it fails to stabilize the Pt nanoparticles. Furthermore, the availability of tyrosinate form of tyrosine at high pH provides a chemically reducing environment around the cluster, thereby allowing further accelerated reduction of metal ions to yield ultra-rule particles of size 1-2 nm. Thus, the methods and materials described herein can be contrasted with prior art methods in which nanoparticles with a well-developed shape and a narrow size distribution are generally in the size range of 100 nm or more (Schrinner 2009).

Proteins offer numerous advantageous properties over other polymers and biomolecules as a potential template towards the synthesis of nanoparticles because of their unique molecular recognition, which triggers a well-defined periodic self-assembly process. The chemistry of interaction and distribution of metallic particles are bound to be dictated by the presence of specific functional amino acid residues available around the protein surface. On the basis of our observations, using rec1-resilin we propose that other resilin proteins may also be capable of templating and/or stabilising the formation of the metal nanoparticles. For example, proteins comprising one or more tyrosine residues could be used.

The elastic protein not only serves to template and stabilize the metal particles as they are forming, the protein also remains in place after they are formed. To this end, we have found that the protein is permeable to all of the ions/reactant present in an electrochemical cell. This is in contrast to attempts in the prior art to template the formation of nanoparticles which also require removal of the template after formation of the metal nanoparticles (D'Souza et al. 2007; Pileni 2003; Shenhar et al. 2005).

The electrocatalyst metal may be platinum, palladium, gold, silver, manganese, iron, magnesium, and alloys of any one or more of the aforementioned metals.

In embodiments, the electrocatalyst metal is platinum metal and/or platinum alloy. In embodiments, the platinum alloy is selected from the group consisting of: Pt/Ru; Pt/Co; Pt/Fe; Pt/Ni; Pt/Mn; Pt/Ti; Pt/Cr; Pt/Cu; Pt/Pd; Pt/Rh; Pt/Ir; Pt/Ag; and Pt/Au. In embodiments, the weight ratio of platinum to metal in the alloy (Pt:M) is from about 100:1 to about 2:1. In embodiments, the weight ratio of platinum to metal in the alloy (Pt:M) is from about 90:1 to about 2:1. In embodiments, the weight ratio of platnum to metal in the alloy (Pt:M) is from about 80:1 to about 2:1. In embodiments, the weight ratio of platinum to metal in the alloy (Pt:M) is from about 70:1 to about 2:1. In embodiments, the weight ratio of platinum to metal in the alloy (Pt:M) is from about 60:1 to about 2:1. In embodiments, the weight ratio of platinum to metal in the alloy (Pt:M) is from about 50:1 to about 2:1. In embodiments, the weight ratio of platinum to metal in the alloy (Pt:M) is from about 40:1 to about 2:1. In embodiments, the weight ratio of platinum to metal in the alloy (Pt:M) is from about 30:1 to about 2:1. In embodiments, the weight ratio of platinum to metal in the alloy (Pt:M) is from about 20:1 to about 2:1. In embodiments, the weight ratio of platinum to metal in the alloy (Pt:M) is from about 15:1 to about 2:1. In embodiments, the weight ratio of platinum to metal in the alloy (Pt:M) is about 10:1 to about 2:1.

In embodiments, the electrocatalyst metal is palladium metal and/or palladium alloy. In embodiments, the palladium alloy is selected from the group consisting of: Pd/Co, Pd/Ni, Pd/Au, Pd/Ru, Pod/Ir, Pd/Mn, Pd/Ti, Pd/Cr, Pd/Cu, Pd/Ag, and Pd/Rh. In embodiments, the weight ratio of platinum to metal in the alloy (Pd:M) is from about 100:1 to about 2:1. In embodiments, the weight ratio of platinum to metal in the alloy (Pd:M) is from about 90:1 to about 2:1. In embodiments, the weight ratio of platinum to metal in the alloy (Pd:M) is from about 80:1 to about 2:1. In embodiments, the weight ratio of platinum to metal in the alloy (Pd:M) is from about 70:1 to about 2:1. In embodiments, the weight ratio of platinum to metal in the alloy (Pd:M) is from about 60:1 to about 2:1. In embodiments, the weight ratio of platinum to metal in the alloy (Pd:M) is from about 50:1 to about 2:1. In embodiments, the weight ratio of platinum to metal in the alloy (Pd:M) is from about 40:1 to about 2:1. In embodiments, the weight ratio of platinum to metal in the alloy (Pd:M) is from about 30:1 to about 2:1. In embodiments, the weight ratio of platinum to metal in the alloy (Pd:M) is from about 20:1 to about 2:1. In embodiments, the weight ratio of platinum to metal in the alloy (Pd:M) is from about 15:1 to about 2:1. In embodiments, the weight ratio of platinum to metal in the alloy (Pd:M) is about 10:1 to about 2:1.

In other embodiments, the electrocatalyst is manganese in the form of manganese oxide. The electrocatalyst nanoparticles may be formed by reducing a manganese nitrate solution in the presence of the elastic protein. These embodiments may be particularly useful for water electrolysis (Mette et al. 2012).

The composition of matter may be used as a catalyst. In embodiments, the electrocatalyst metal nanoparticles dispersed in a protein matrix comprising an elastic protein are bound to a suitable support. Suitable supports include carbon-based, alumina, silica, silica-alumina, titania, zirconia, calcium carbonate, barium sulphate, a zeolite, interstitial clay, and the like. The catalyst may be used for hydrogenation and dehydrogenation reactions of hydrocarbons, carbon-carbon cross-coupling reactions, hydrosilylation reactions, and the like. Platinum catalyst is also widely used in automobiles as a catalytic converter, which allows the complete combustion of low concentrations of unburned hydrocarbons from the exhaust into carbon dioxide and water vapor. Platinum is also used in the petroleum industry as a catalyst in a number of separate processes, but especially in catalytic reforming of straight run naphthas into higher-octane gasoline which becomes rich in aromatic compounds. PtO₂, also known as Adam's catalyst, is used as a hydrogenation catalyst, specifically for vegetable oils. Platinum metal also strongly catalyzes the decomposition of hydrogen peroxide into water and oxygen gas.

Alternatively, the composition of matter may form part of an electrochemical sensor for use in biosensing applications.

The electrocatalyst metal nanoparticles dispersed in the protein matrix may be coated or otherwise deposited onto an electrically conductive support to provide an electrode. Thus, the present invention also provides an electrode comprising an electrically conductive support and catalytic metal nanoparticles dispersed in a protein matrix comprising a resilin family protein or homolog thereof on the electrically conductive support. The electrode may be an oxygen-reducing cathode.

The electrically conductive support may be any high surface area conductive material known in the art. In embodiments, the electrically conductive support is carbon-based. Some examples of carbon-based electrically conductive supports include carbon black, graphitized carbon, graphite, activated carbon, carbon nanotubes, fullerenes, graphene and the like. In specific embodiments, the electrically conductive support comprises carbon nanotubes. Suitable carbon nanotubes include single wall carbon nanotubes and multiwalled carbon nanotubes (MWCNTs). In specific embodiments, the electrically conductive support comprises MWCNTs.

The electrode may be formed by providing a solution or suspension containing ions of the electrocatalyst metal and the elastic protein or homolog or fragment thereof; contacting the solution with a reducing agent under conditions to reduce the ions of the electrocatalyst metal to electrocatalyst metal to provide a reduced solution comprising electrocatalyst metal nanoparticles dispersed in a protein matrix comprising an elastic protein or homolog or fragment thereof; and contacting the reduced solution with the electrically conductive support material under conditions to deposit at least some of the electrocatalyst metal nanoparticles dispersed in the protein matrix comprising an elastic protein or homolog or fragment thereof on the surface of the support.

The electrode may form part of an electrochemical half-cell comprising the electrode and a housing for maintaining an electrolyte in contact with the electrode.

In a further aspect, the present invention provides a fuel cell comprising an electrolyte membrane and an anode and a cathode sandwiching said electrolyte membrane, at least one of said cathode and anode comprising an electrically conductive support and catalytic metal nanoparticles dispersed in a protein matrix comprising an elastic protein or homolog or fragment thereof on the support.

In embodiments, the fuel cell comprises an oxygen-reducing cathode comprising an electrically conductive support and catalytic metal nanoparticles dispersed in a protein matrix comprising an elastic protein or homolog or fragment thereof on the support. The oxygen-reducing cathode is in electrical contact with a fuel-oxidizing anode. The anode of the fuel cell can be any of the anodes known in the art. For example, the anode can include supported or unsupported platinum or platinum-alloy compositions. The anode can also include a carbon monoxide-tolerant electrocatalyst. Such carbon monoxide tolerant anodes include numerous platinum alloys.

Alternatively, or in addition the anode of the fuel cell may comprise an electrically conductive support and catalytic metal nanoparticles dispersed in a protein matrix comprising an elastic protein or homolog or fragment thereof on the support.

The structure of a typical electrode in a fuel cell includes 1) a fluid permeable side with hydrophobic characteristics and 2) a catalytic side having the electrocatalyst. The catalytic side is in direct contact with a liquid or solid electrolyte (e.g., a proton-conducting medium).

The hydrophobic characteristics on the electrode can be provided by one or more substances which are suitably hydrophobic, adhere to the electrode, and do not interfere with the electrochemical process. Suitable hydrophobic substances include fluorinated polymers such as polytetrafluoroethylene (PTFE), polytrifluorochloroethylene, and copolymers composed of tetrafluoroethylene and one or more other fluorinated or non-fluorinated monomers.

The electrode(s) of the fuel cell can be any of various shapes, including tubular, rod-like, or planar.

In the fuel cell, an ion-conducting electrolyte is in mutual contact with the cathode and anode. The ion-conducting electrolyte conducts either protons or reduced oxygen species from one electrode to the other while separating the fuel at the anode from the oxidant at the cathode. The ion-conducting electrolyte can be a liquid, solid, or semi-solid. In embodiments, the ion-conducting electrolyte is proton-conducting, i.e. selectively conducts protons from the anode to the cathode. The proton-conducting electrolyte may be a solid or semi-solid proton-conducting membrane. Suitable proton-conducting polymer electrolytes include the commercially available copolymers of tetrafluoroethylene and perfluorinated vinyl ethers marketed under the trade name NAFION® (DuPont).

The fully assembled fuel cell can have stack designs to increase the electrical output. For example, any of the known stack configurations designed for compactness and efficient supply of fuels to the anode and oxygen to the cathode can be used.

In still a further aspect, the invention provides a method for producing electrical energy from the fuel cell described above. The fuel cell, as described, becomes operational and produces electrical energy when the oxygen-reducing cathode is contacted with an oxidant, such as oxygen, and the fuel-oxidizing anode is contacted with a fuel source.

Oxygen gas can be supplied to the oxygen-reducing cathode in the form of pure oxygen gas. Pure oxygen gas is particularly preferable for use in alkaline fuel cells.

In the case of acid electrolyte fuel cells, the oxygen gas is more preferably supplied as air. Alternatively, oxygen gas can be supplied as a mixture of oxygen and one or more other inert gases. For example, oxygen can be supplied as oxygen-argon or oxygen-nitrogen mixtures.

Some contemplated fuel sources include, for example, hydrogen gas, alcohols, methane, gasoline, formic acid, dimethyl ether, and ethylene glycol. Some examples of suitable alcohols include methanol and ethanol. For alkaline fuel cells, the hydrogen gas is preferably very pure, and accordingly, free of contaminants such as carbon dioxide which degrade the strongly alkaline electrolyte.

The fuels can be unreformed, i.e., oxidized directly by the anode. Alternatively, the fuels can be used indirectly, i.e., treated by a reformation process to produce hydrogen. For example, hydrogen gas can be generated and supplied to the anode by reforming water, methanol, methane, or gasoline.

In a further aspect, the present invention provides a method of preparing nanoparticles of a metal, the method comprising reducing ions of the metal in the presence of a protein comprising an elastic protein or homolog or fragment thereof to provide metal nanoparticles dispersed in a protein matrix comprising an elastic protein or homolog or fragment thereof.

In embodiments, the method comprises: providing a solution or suspension containing ions of the metal and the protein comprising an elastic protein or homolog or fragment thereof; contacting the solution with a reducing agent under conditions to reduce the ions of the metal to metal to provide a reduced solution comprising metal nanoparticles dispersed in a protein matrix comprising an elastic protein or homolog or fragment thereof.

In embodiments in which the metal is an electrocatalyst metal, the method further comprises; contacting the reduced solution with an electrically conductive support material under conditions to deposit at least some of the electrocatalyst metal nanoparticles dispersed in the protein matrix comprising an elastic protein or homolog or fragment thereof on the surface of the support.

The support may be a high surface area carbon, alumina or silica material. In specific embodiments, the support comprises fullerenes, graphene, carbon nanotubes, carbon nanobuds, and or carbon nanofibres. Suitable carbon nanotubes include single wall carbon nanotubes and multiwalled carbon nanotubes (MWCNTs). For example, Pt based nanoparticles may be formed on carbon nanotubes functionalised with an elastic protein, such as a resilin family protein. In this case red-resilin is pre-adsorbed on the carbon support followed by addition of a Pt precursor for reduction.

### EXAMPLES

### Example 1

### Preparation of Rec1-Resilin

The resilin-mimetic protein polymer rec1-resilin has been synthesized by recombinant DNA technology. The exon-1 of the Drosophila melanogaster gene CG15920 was cloned and expressed in Escherichia coli and was purified, the details of the synthesis procedure as described before (Elvin et al. 2005). The soluble protein rec1-resilin, thus prepared has concentration range from 200 to 300 ml⁻¹. Structurally rec1-resilin consists of 310 amino acid residues, (molecular weight: 28.492 kD) containing repeat sequences of the resilin gene CG15920 (19-321 residues in the N-terminal region of a 620 amino acid sequence). The structural consensus is given in FIG. 1. rec1-resilin solutions of required concentration were prepared in phosphate buffered saline (PBS) unless otherwise indicated.

### Example 2

### Preparation of Pt-Colloids and Pt-Nanoparticles Stabilized with Rec1-Resilin at Different Pt Concentration

To investigate the effect of platinum precursor concentration to rec1-resilinon the assembly of nanoparticles, different molar ratios ‘R’ of Pt-ion to rec1-resilin were chosen (Table 1) and the reduction protocol was followed at pH 7.4.

A stock solution of 0.35 μM rec1-resilin was prepared in a conical flask. Next a series of 0.024, 0.24, 1.2 and 2.4 mM of H₂PtCl₆ solutions, dissolved in water was mixed thoroughly (via sonication) with 3 ml of rec1-resilin solution (adjusted to pH 7.4) to yield four different sets of Pt metallated samples. The samples were reduced with sodium borohydride, (1.5×molar concentration of H₂PtCl₆ in water to ensure complete reduction) thus resulting in Pt/rec1-resilin colloid. The color of the solutions turned light brown from pale yellow and black at low and high concentration of Pt respectively.

TABLE 1
Concentration and molar ratio of platinum rec1-resilin system

| | | | Molar | Molar | TEM |
|---|---|---|---|---|---|
| | | rec1- | ratio | ratio | Inter- |
| Sample | H₂PtCl₆ | resilin | H₂PtCl₆/ | Pt/rec1- | particle |
| desig- | Conc | Conc. | rec1- | resilin | Distance |
| nation | (mM) | (mM) | resilin | (R) | (nm) |
| P0 | 0 | 0.35 × 10⁻³ | — | — | — |
| P1 | 0.024 | 0.35 × 10⁻³ | 7.14 | 14.7 | Aggregated |
| P2 | 0.24 | 0.35 × 10⁻³ | 71.4 | 147 | 5-10 |
| P3 | 1.2 | 0.35 × 10⁻³ | 344.8 | 735 | 1-2 |
| P4 | 2.4 | 0.35 × 10⁻³ | 689.6 | 1464 | connected |

Absorption spectra, fluorescence and light scattering spectra of the prepared solutions were measured using a CARY 1E Scan UV-vis spectrometer, CARY Eclipse fluorescence spectrophotometer and Malvern Zeta Sizer nano ZS, ZEN3600 spectrometer respectively. TEM images were acquired with Philips 200 EX electron microscope. The samples for TEM studies were prepared by placing a drop of the solutions on carbon-coated copper grids followed by drying.

All electrochemical measurements were carried out on an electrochemical workstation (Solatron 1287) using a conventional three-electrode cell with a platinum counter electrode and Ag/AgCl (0.2 vs. NHE) reference electrode. Cyclic voltammetry (CV) was carried out in a classic cell equipped with three electrodes: glassy carbon working, platinum auxiliary and an Ag/AgCl reference electrode. The working electrode for electrochemical experiment was prepared by thin film electrode method. A polished glassy carbon electrode (GC, 5 mm dia) was used as a substrate. A 10 μl suspension of Pt/MWCNT catalyst in water solution was carefully transferred onto GC substrate. After evaporation of water, the deposited catalyst was covered with 4 μl Nafion solution (0.5 wt % DuPont), resulting in a typical metal loading of 16-20 μg/cm².

To investigate the electrooxidation of methanol using CV, the electrolyte was a 0.5 mol L⁻¹ solution of methanol and sulphuric acid. The electrochemical measurements were carried out in a three-electrode cell at 298 K. Unless otherwise specified, the electrolyte solutions were first de-aerated with high-purity (HP, 99.9%) nitrogen prior to any measurement; the experimental scan rate (V/s) was 50 mV/s.

The electrochemically active surface area (ECSA) was estimated by measuring the charge associated with H_{upd} adsorption (qH) between 0 and 0.37 V and assuming 210 μC/cm² for the adsorption of a monolayer of hydrogen on a Pt surface (qH). The accelerated durability tests were performed at room temperature by applying cyclic potential sweeps between 0 and 1.1 V versus RHE (reversible hydrogen electrode (RHE) is a reference electrode) at a sweep rate of 50 mV/s for a given number of cycles.

The variation of interparticle distance and organization of Pt⁰ with the change in ‘R’ is shown in FIG. 2. The size and assembly of Pt nanoparticles are found to change progressively with change in ‘R’. At a low molar concentration of platinum precursor such as 0.024 mM level (sample) most of the Pt nanoparticles remained as aggregates, only a fraction of the particles remained dispersed separately. Due to high Pt/rec1-resilin binding affinity, in presence of excess protein the Pt nanoparticles aggregate are encapsulated and the agglomerations are non-directional and irregular (Lisiecki 2005). When the molar concentration of the precursor is increased to 0.24 mM (R=147, sample P2), the particles are found to extensively self-organise into periodic nanostructures and are monodispersed with an average diameter of 2-3 nm (FIG. 2(b)). On further increase of R to 735 (sample P3), the particles exclusively self-assemble into fishnet-like structures and the particles are arranged in ordered discrete nanoparticles packed around the central protein core (FIG. 2(c)). At a very high level of H₂PtCl₆ (R=1464), the TEM micrograph confirms that Pt nanoparticles retain the network patterns and form ordered mesoporous materials with high metal content from the co-assembly of bio-macromolecule with the metallic nanoparticles. Such remarkably dense mesoporous structures of Pt-catalytic nanoparticles are crucial for the development of fuel cell electrodes and other devices (Warren et al. 2008). The progressive change in the organization in the sols with increased level of nanoparticles is also evidenced by significant change in DLS spectra and UV-vis absorbance spectra (Table 2), and reflects the assembly of NP in solution directed by the combined secondary force of interactions towards the generation of novel Pt nanoassembly.

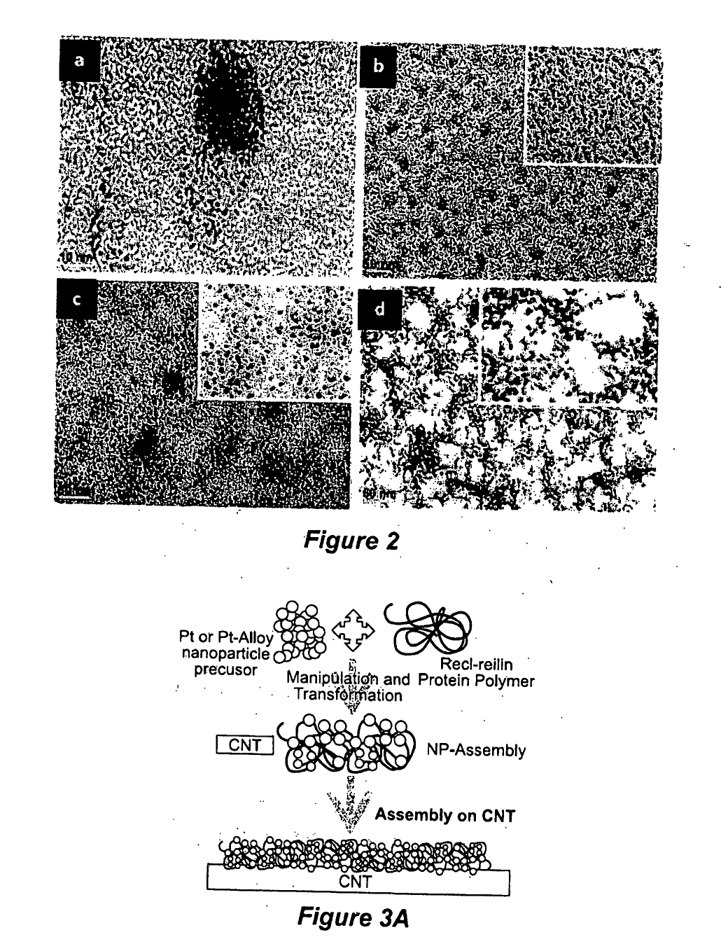

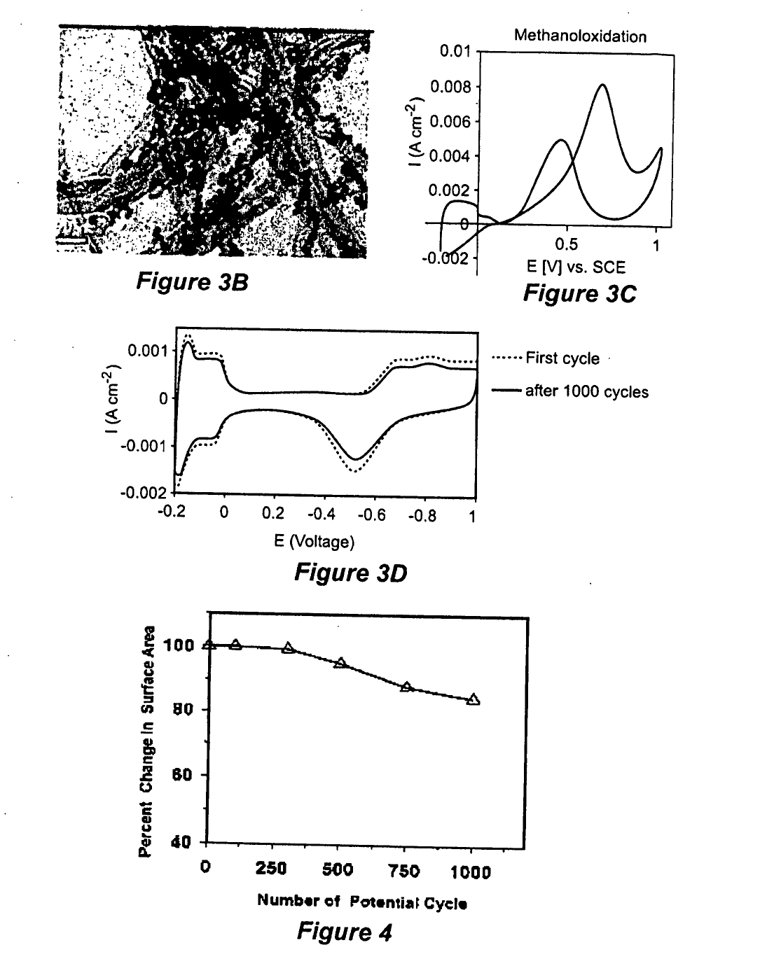

It is not only the surface area but also the accessibility, electrocatalytic activity and stability of the Pt nanoparticles that are crucial parameters for electrocatalysts in demanding applications such as fuel cells. To evaluate the electrocatalytic efficiency of Pt nanoparticles so produced, functional hetero structures were fabricated using the precursor concept (Richards et al. 2001) (FIG. 3(a)); and Pt nanoparticles were deposited using sample P4 onto the walls of functional multi walled carbon nanotube (MWCNT) (FIG. 3(b)). Subsequently, the electrocatalytic activities of the Pt nanoparticles were examined for reactions of methanol oxidation reaction (MOR), related to the performance of a direct methanol fuel cell (DMFC).

The electrochemically active surface area, (ECSA, cm²mg⁻¹ Pt) was obtained from the cyclic voltammogram (CV) and was calculated from the charge transfer (Q_{H}, mC mg⁻¹ Pt) for the hydrogen adsorption and desorption in the hydrogen region (−0.16-0.2 V) as follows:

ECSA=QH/0.21×Lₚₜ (1)

where, Lₚₜ is the Pt loading (mg), QH is the charge for H₂ adsorption and 0.21 is the charge required to oxidize a monolayer of H₂ on smooth Pt (mC/cm²) (Shao et al. 2006). The chemical specific surface area (CSA, cm² mg⁻¹ Pt). of Pt nanoparticles can be calculated from following equation with the assumption that all particles are in spherical in shape: CSA=6/pd, where ρ is the density of Pt (21.4 g/cm³) and d (nm) is the mean diameter of the Pt nanoparticles in the catalyst. The ECSA and CSA for Pt/MWCNT are 57.14 and 63.22 m²/gPt, respectively. The Pt utilization, which is defined as the ratio of the ECSA and CSA, because it can provide information on how many surface Pt atoms are active in electrochemical reactions (Liu et al. 2004).

Pt utilization(%)=(ECSA/CSA)×100 (2)

Using the above equation (1), the Pt utilization of Pt/MWCNT/rec1-resilin found to be 90.4%.

Methanol oxidation voltammogram (FIG. 3(c)) confirms that the Pt heterostructures are highly active and enable the shift of onset potential of MOR from 0.13V to 0.11 V vs. SCE and a very high mass activity of 206 mA cm² (90% Pt catalyst utilization, as discussed above). In the forward scan, methanol oxidation produces a prominent symmetric anodic peak (I_{f}) at ˜0.67 V. In the reverse scan, an anodic peak (I_{b}) appeared at ˜0.58V (attributed to the removal of the incompletely oxidized carbonaceous species formed in the forward scan). The ratio of the forward anodic peak current (I_{f}) to the reverse anodic peak (I_{b}) current is generally used to describe the catalyst tolerance (Hsieh et al. 2009) to carbonaceous species accumulation towards oxidation of methanol to CO₂ and a high I_{f}/I_{b} value of 1.8 implies excellent oxidation of methanol to CO₂. Earlier work reported the ratio of 0.87 with a nanosized Pt on XC-72 synthesized by a microwave assisted polyol process (Hsieh et al. 2009). This result also underpins the effectiveness of this synthesis compared to nanoparticles synthesized using classical self-assembly of block-copolymer; which impedes the reactant accessibility to active particles resulting in reduced electrochemical activity of nanoparticles. Traditionally for fuel cell applications, such polymer-nanoparticle hetero-structures are activated by heating the pyrolysed sample in air to high temperature (˜500° C.) to remove the protective layer that causes microstructure collapse and sintering of nanoparticles resulting in reduced activity.

The degradation of Pt/MWCNT electrocatalyst was evaluated by repeated cyclic voltammetry (CV) cycles between 0 and 1.2 V versus a reversible hydrogen electrode (RHE) at a scan rate of 50 mV/s in a nitrogen purged 0.5 M sulphuric acid solution at room temperature. The platinum surface area of the Pt/MWCNT retains more than 86% of the ECSA even after 1000 degradation cycles (FIG. 4).

The voltammograms of Pt heterostructures before and after 1000 potential cycles are shown in FIG. 3(d). The voltammograms display two expected distinctive potential regions: (i) between −0.18<E<0.1 V (vs. SCE) associated with H_{upd} (upd is under potentially deposited) adsorption/desorption processes (H⁺+e⁻=H_{upd}) and (ii) the formation of a OH_{ad} layer (2H₂O=OH⁻_{ad}+H₃O⁺+e⁻) beyond ˜0.57 V vs. SCE, where H_{upd}and OH_{ad} refer to the under potentially deposited hydrogen and the adsorbed hydroxyl species, respectively. The hydrogen adsorption (HUD) area and its evolution in subsequent electrochemical cycling were used to determine the recordable loss of electrochemically active surface area (ECSA) of Pt nanoparticles. The specific ECSA (the ECSA Or unit weight of Pt) of Pt in Pt/MWCT is observed to be 57.14 m²/gPt which is comparable to the high surface area Pd—Pt nanodendrites (57.1 m²/gPt) electrocatalyst recently reported by Lim et al. using polymer as template (Lim et al. 2009). The accelerated durability test using CV measurements demonstrated that after 1000 cycles, PT/MWCT catalysts retained 84% of the initial ECSA in comparison to the reported value of only ˜49% of the initial ECSA (Lee et al. 2007) in case of commercial catalyst (platinum supported on carbon black) suggesting excellent durability. Recently, Zhang et al. reported the stabilization of Pt electrocatalysts against Pt dissolution by alloying it with Au clusters, which were deposited onto the carbon-supported Pt nanoparticles through a galvanic replacement reaction (Zhang et al. 2007). Stamenkovic et al. demonstrated that PtNi single-crystal electrode surface activity is 10-fold over a single-crystal platinum and 90-fold over the standard Pt/C combination (Stamenkovic et al. 2007). Thus further enhancement of catalytic activity and stabilization is envisaged through the synthesis of bimetallic Pt nanoparticles of different composition, morphology and assembly using the harnessed rec1-resilin template to confined synthesis of alloys particle from appropriate metallic precursors.

Dynamic light scattering (DLS) was employed to monitor the conformational shifts of proteins with the adsorption of Pt (Table 2). It provides information on the size of colloidal fractal structure and structural changes in response to change in solution conditions. It is evident from the DLS results that for low R value (14.7), dramatic increase in the average Dₕ (from 11 to 67 nm) is observed, indicating that the loose and non-structured rec1-resilin-Pt aggregates are formed at this concentration. Upon increase of ‘R’ value, the decrease in average Dₕ can be clearly observed, indicating the formation of well-defined rec1-resilin/Pt aggregates resulting from strong interactions between Pt ions and functional residues of rec1-resilin. But at very high R values (1464), the average Dₕ increases to relatively high value indicating a significant change in the interaction between rec1-resilin and Pt.

TABLE 2
Characteristics of Pt/rec1-resilin bioconjugates at
various precursor molar concentrations (R value)

| | | Pt/rec1- | | | | TEM |
|---|---|---|---|---|---|---|
| | | resilin | | | | Inter- |
| H₂PtCl₆ | | molar | DLS | PDI | TEM | particle |
| Conc. | | ratio | Dₕ (Z_{avg}) | from | Size | Distance |
| (mM) | | (R) | nm | DLS | (nm) | (nm) |
| 0 | (P0) | — | 11.2 | 0.29 | — | — |
| 0.024 | (P1) | 14.70 | 67 | 0.85 | 1-2 | Aggregated |
| 0.24 | (P2) | 147 | 41 | 0.74 | 3 | 5-10 |
| 1.2 | (P3) | 735 | 30 | 0.24 | 3-5 | 1-2 |
| 2.4 | (P4) | 1464 | 90 | 0.50 | Non-spherical | Connected |

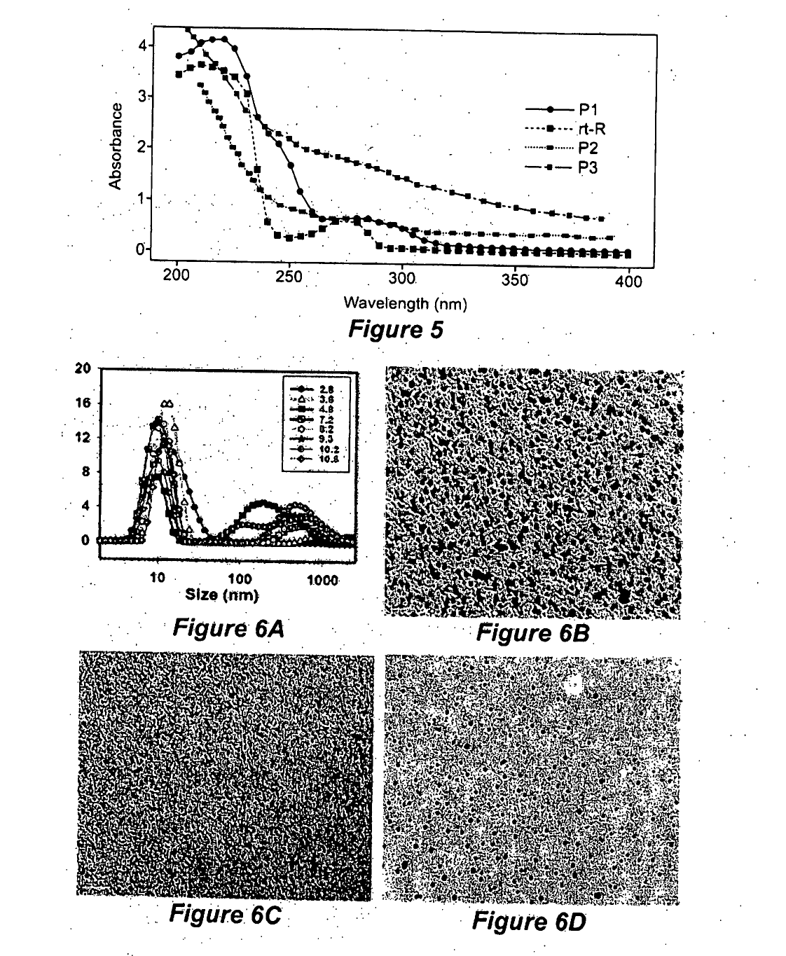

The results of a UV-vis absorbance study are shown in FIG. 5. Neat rec1-resilin solution shows a distinct absorption peak at 276 nm, corresponding to tyrosine residues. At low concentration of H₂PtCl₆ (P1, 0.024 mM), the absorbance peak is proximal to 270 nm, and it is stronger and narrower (see FIG. 5), which indicates that the Pt nanoparticles are relatively strongly dispersed in the solution (Wang et al. 2006). As the concentration of Pt is increased (see FIG. 5 for 0.24 (P2) and 1.2 mM (P3)), the peaks become broader and new peaks are evident at longer wavelengths, suggesting the assembly/agglomeration of Pt nanoparticles in the solution. Moreover, the very presence of long wagging tail and high absorption over the whole region for P3, is indicative of the presence of very closely interconnected Pt nanoparticles. It can be concluded that the change of Pt concentration in pure red-resilin at pH 7.4 has influenced the conformation and assembly of the Pt nanoparticles in the solution (Si et al. 2006).

### Example 3

### Preparation of Pt-Colloids and Pt-Nanoparticles Stabilized with Rec1-Resilin at Digerent pH

A stock solution of 0.35 μM rec1-resilin was prepared in a conical flask using PBS. Next 1 ml of 0.24 mM of H₂PtCl₆ solution dissolved in water was mixed thoroughly (via sonication) with 3 ml of rec1-resilin solution adjusted to required pH. The samples were finally reduced with sodium borohydride, (1.5×the amount of H₂PtCl₆ in water to ensure complete reduction) thus resulting in Pt/rec1-resilin colloid. The color of the solutions turned light brown from pale yellow within seconds, while precipitation of colloids occurred within minutes after preparation at low pH (2.8).

DLS experiments were performed to establish the conformational changes of rec1-resilin with pH and upon binding Pt nanoparticles. These experiments provide information on hydrodynamic diameter (Z_{avg}) Dₕ and polydispersity index (PDI) of the solution of rec1-resilin, and rec1-resilin/Pt complex, which gives indirect information on the conformation (Table 3).

FIG. 6(a) illustrates the pH induced changes on the hydrodynamic diameter (measured from DLS analysis) of rec1-resilin in 0.35 μM aqueous solution in PBS. The hydrodynamic diameter, Dₕ and polydispersity (PDI) information are given in Table 3.

TABLE 3
Characteristics of rec1-resilin and Pt/rec1-resilin at various
pHs (Dh: hydrodynamic diameter, PDI: polydispersity index)

| | rec1- | | Pt/rec1- | |
|---|---|---|---|---|
| | resilin | rec1- | resilin | Pt/rec1- |
| | Dₕ (Z_{avg}) | resilin | Dₕ (Z_{avg}) | resilin |
| pH | nm | PDI | nm | PDI |
| 2.8 | 9.2 | 0.07 | 116 | 0.94 |
| 7.4 | 11.1 | 0.29 | 41.4 | 0.779 |
| 8 | 16.3 | 0.43 | — | — |
| 9.3 | 13.9 | 0.46 | — | — |
| 12 | 18.2 | 0.54 | 20.8 | 0.609 |

At pH<PI (pH=2.8), there is a dramatic increase in Dₕ (9.2 (pH 7) to 116 nm (pH 2.8)) and PDI (from 0.073 to 0.94) with the formation of Pt, which clearly indicates that highly polydispersed, non-structured loose rec1-resilin-Pt aggregates are formed at this pH. At pH>pD (pH=12) there is an increase in Dₕ by 2-3 nm upon assembly of Pt with rec1-resilin indicating the monolayer coverage of Pt nanoparticles i.e. r1-R at pH 12 acts as a flexible linear chain with more open and random structure. At pH greater than PI but less than pD (pD is the pH (˜10.5), at which tyrosine becomes tyrosinate-ionized tyrosine, e.g. pH 7.4), there is an increase in the Dₕ by 28-30 nm, roughly equal to three single layer of intact rec1-resilin between and covering the nanoparticles, indicating an organized structure.

At pH of 2.8 and 3.4 (pH<pI) the protein is positively charged with hydrodynamic diameter, Dₕ of ˜9.2 nm, with polydispersity index, PDI<0.1 confirming the narrow distribution of the ensemble of structures. At pH>pI<pD, the protein surface is negatively charged and Dₕ of rec1-resilin grows to ˜11 nm with increased PDI of ˜0.290. However, at pH>pD the surface charge becomes strongly negative with Pₕ increased to ˜18.2 nm along with significant increase in PDI (0.545) indicating uncoiling and broader distribution of the ensemble of structures. This progressive change in the protein conformation with pH, is also reflected in the large changes in the fluorescence and UV absorbance spectra of rec1-resilin. At pH>pD (˜pH 10.5), the hydroxyl group of Tyr becomes deprotonated and the Tyr residues in “tyrosinate” form are highly hydrophilic and accessible (O'Neil et al. 1987; Carra et al. 2003). The progressive unfolding of proteins with pH results in the exposure of novel binding sites for metallic precursors; each featuring distinct characteristics and kinetics in controlling the size and assembly of metallic particles—a key factor in determining catalytic, electronic and optical response in nanoparticle based systems. This concept has been implemented with the addition of platinum precursor into the solution of rec1-resilinat various pH conditions followed by the reduction to zero valent Pt nanoparticles using NaBH₄. FIG. 6(b) displays the TEM images of PtNP/rec1-resilin bioconjugates (PtBCs) at a pH 7.4 which confirms the presence of monodisperse Pt particles of size 2-3 nm. However, ultra-fine particles of size ranging from 0.75 -1.5 nm is observed at a pH 11.7 (pH>pD) (FIG. 6(c)). Unlike pH 7 and 11.7 (FIGS. 6(b), (c)), a colloidal solution of protein polymer at low pH (pH<pI) exhibits very little capability to stabilize Pt colloids (precipitation is evident with the addition of NaBH₄); and the TEM micrograph (FIG. 6(d)) of the supernatant solution shows the presence of very large particles. In these systems, the steric stabilization does not appear to provide colloidal stability of the sols as it fails to stabilize the Pt nanoparticles at PI (pH ˜4.8). At pH below pI, the protein ensemble surface is positively charged and compact; and unable to stabilize platinum nanoparticles. At PI>pH<pD the protein ensemble surface is negatively charged and swollen; and amino acid residues are capable of assembling and stabilizing Pt nanoparticles (FIG. 6(b)). The availability of tyrosinate form of tyrosine at high pH>pD provides a chemically reducing environment around the cluster, thereby allowing further accelerated reduction of Pt ions to yield ultrafine particles of size 1-2 nm (FIG. 6(c)).

The observation indicates that the PtCl6²⁻ interacts with rec1-resilin and directs intimate changes in its microenvironment. Thus pH change can be used as a nanoswitch, and can be used successfully to release the binding sites required to tune the size and organization of nanoparticles.

### Example 4

### Preparation of Pt Alloy Supported Catalysts Stabilized with Rec1-Resilin

Alloys of Pt were synthesized by extending the protocol towards the synthesis of Pt/MWCNT as follows. Multiwalled carbon nanotubes (MWCNT) were firstly functionalized via sonochemical oxidation. The corresponding metallic salts of hexachloroplatinic acid, ruthenium chloride trihydrate, cobalt nitrate trihydrate and gold (III) chloride (H₂PtCl₆, RuCl₃.3H₂O, Co(NO₃)₂.3H₂O and AuCl₃.3H₂O) were added to 0.1 wt % solution of rec1-resilin with Pt:M weight ratio of 10:1. After that a solution of NaBH₄ (0.5 wt %) was added drop wise and the resulting colloidal solution was maintained under sonication for one hour to allow complete reduction. Then functionalized MWCNT was added, the suspension was sonicated, centrifuged and the solid product was collected and analysed.

The as-prepared catalysts were characterized by TEM and XPS. The morphology of the catalysts was acquired with a Philips 200 EX transmission electron microscope. The samples for TEM studies were prepared by placing a drop Of the solutions on carbon-coated copper grids followed by drying. The XPS measurements were performed using a Kratos axis ultra spectrometer, by coating a drop of the sample solutions onto a silica substrate. The spectra were collected with pass energy of 160 eV for wide scan and 20 eV for high resolution scan.

### Example 5

### Preparation of Working Electrodes

A working electrode was prepared using a thin film electrode method. A polished glassy carbon electrode (GC, 5 mm diameter) was used as a substrate. A 10 μl suspension of Pt/MWCNT catalyst in water was carefully transferred onto a GC substrate. After evaporation of water, the deposited catalyst was covered with 4 μl Nafion solution (0.5 wt % DuPont), resulting in a typical metal loading of 16-20 μg cm⁻².

The working electrodes were firstly characterized in 0.5 M sulphuric acid solutions at a scan rate of 50 mV/s by cyclic voltammetry (CV). CV was carried out in a classic cell equipped with three electrodes: platinum working, platinum auxiliary and an Ag/AgCl reference electrode. The CV measurements for methanol catalytic activity and its tolerance towards CO generated during methanol oxidation were carried out in a solution of 0.5 M methanol and 0.5 M sulphuric acid at a scan rate of 50 mV/s. Electrode kinetics and their activity towards oxygen reduction reaction were measured using rotating disk electrode (RDE) in oxygen saturated solution of 0.5 M sulphuric acid. All polarization measurements were performed under a rotation speed of 2000 rpm and a scan rate of 10 mV/s. All electrochemical measurements were carried out on an electrochemical workstation (Solatron 1260) using a conventional three-electrode cell with a platinum counter electrode and Ag/AgCl electrode (0.2 vs NHE) reference electrode.

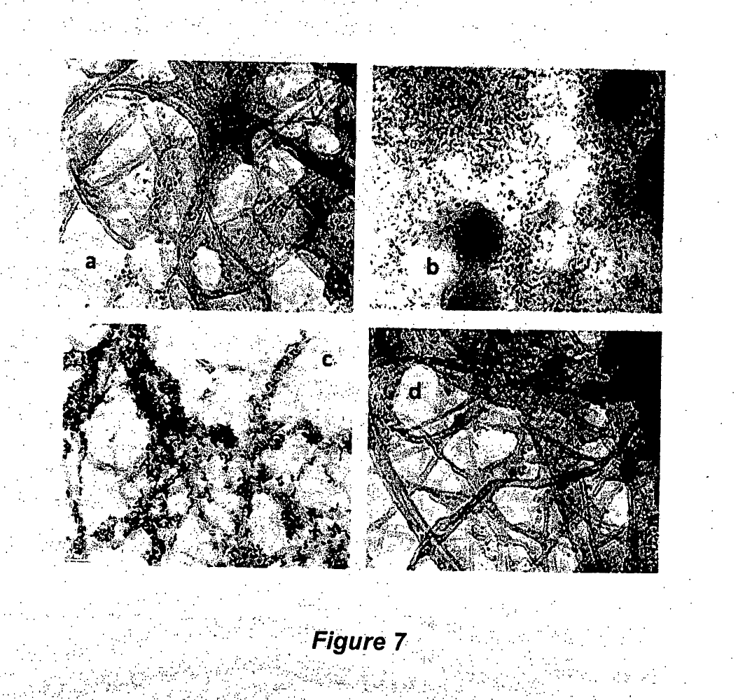

FIG. 7 shows representative TEM images of the experimental Pt, Pt-M/MWCNTs catalytic heterostructures. As evident from the Figure, the catalysts are preferentially distributed over the MWCNT support, without random distribution in the matrix and pronounced particle agglomeration. The average particle sizes of catalysts are in the range 3-5 nm. Energy-dispersive X-ray (EDX) spectrum (collected from the sample imaged by TEM) confirms the existence of corresponding metal peaks of Pt, Pt:Au, Pt:Co, Pt:Ru in their respective sols. These observations confirm the power of rec1-resilin to co-assemble different components of the heterostructure to make an electrocatalytic heterostructure.

X-ray Photoelectron Spectroscopic (XPS) Investigation of Pt-M (Pt—Au, Pt—Co, Pt—Ru)/MWCNT Catalyst

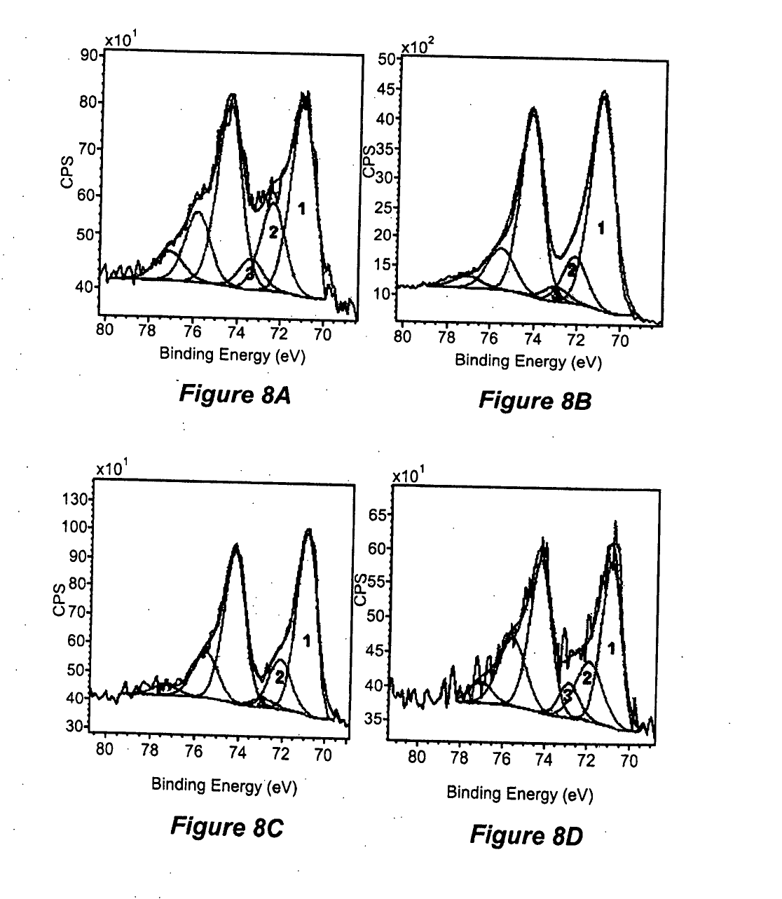

XPS is a powerful technique to prove not only the chemical state information of the materials under examination but also considerable amount of information about the electronic properties of the samples depending on the nature of the material under examination. X-ray photoelectron spectra of the Pt-M/MWCNT supported electrocatalysts examined show Pt4f, O1s and C1s signals and the binding energies of all peaks are referenced to a C1s value of 284.6 eV. FIG. 8 shows the high resolution sweeps of the Pt (40 X-ray photoelectron spectra (XPS) of MWCNT supported Pt, Pt—Co, Pt—Ru and Pt—Au electrocatalysts and provides insight into the nature and relative composition of chemical species at the catalyst surface. For all samples the Pt (4f7/2) spectra could be deconvoluted into three components labeled as 1, 2 and 3 respectively in FIG. 8. The components 1, 2 and 3 relate to Pt, PtO and PtO₂ signals with corresponding binding energy of 70.8, 72.1 and 73.4 eV respectively. Oxygen chemisorption easily occurs at step and kink sites present on the surface of the Pt clusters. The binding energies for the Pt-4f7/2 signals for the different envisaged components and the relative intensities (%) of the three components are given in Table 4. The examination of Table 4 confirms that Pt0 is the predominant species in both Pt and Pt-M (Au, Co, Ru) electrocatalysts. The amount of Pt oxides in Pt>PtCo>PtRu>PtAu, observed suggests that PtAu electrocatalyst has the lowest oxidized components among the catalyst systems investigated. Peaks due to metallic Au, Co, and Ru were not observed in XPS spectra of Pt-M electrocatalysts, possibly due to effects of lower Au, Co and Ru content (0.1 wt %). The binding energy of Pt 4f signals (shown in Table 4) of all the Pt-M (Au, Co, Ru) catalyst shifts in negative direction with alloying. In the literature this effect has been explained in terms of change in the electronic structure of Pt in bimetallic catalyst (Aricò et al. 2001; Tang et al. 2009). Before alloying, the Fermi level of Pt is higher than that of Co or Au or Ru. With the addition of Co or Au or Ru, and formation alloy particle there is a transfer of d-electron density from Pt to Ru (or Au or Co), which effectively lowers the binding energy of d-electrons as observed in FIG. 8 and Table 4. The shift also indicates the atomic mixing between Pt and Co or Ru or Au with no phase separation (Aricò et al. 2001). This is also observed from Table 4 that the amount of platinum oxide content decreases remarkably in the case of Pt—Au and Pt—Ru alloy electrocatalyst.

TABLE 4
Binding energies and relative intensities of different
platinum species as observed from Pt (4f7/2) X-ray
photoelectron spectra of various MWCNT supported
Pt, Pt—Co, Pt—Au and Pt—Ru electrocatalysts.

| | | | Binding | Relative |
|---|---|---|---|---|
| Electro- | | | energy Of | intensity |
| catalyst | Species | | Pt(4f_{7/2}/eV) | (%) |
| Pt/MWCNT | 1 | Pt | 71.03 | 61 |
| | 2 | Pt—O | 72.4 | 29 |
| | 3 | PtO₂ | 73.4 | 10 |
| Pt—Au/ | 1 | Pt | 70.8 | 78 |
| MWCNT | 2 | Pt—O | 72.1 | 16 |
| | 3 | PtO₂ | 73 | 6 |
| Pt—Ru/ | 1 | Pt | 70.9 | 73 |
| MWCNT | 2 | Pt—O | 72.1 | 23 |
| | 3 | PtO₂ | 73 | 4 |
| Pt—Co/ | 1 | Pt | 70.9 | 59 |
| MWCNT | 2 | Pt—O | 71.9 | 28 |
| | 3 | PtO₂ | 72.9 | 13 |

From FIG. 8 for all the experimental samples three pairs of deconvoluted platinum peaks are clearly evident. The most intense pairs, located around 71 and 74 eV are attributed to metallic platinum: Pt 4f7/2 and Pt 4f5/2. The exact positions of these peaks are affected by the interactions between Pt and neighbouring elements. The second pair of Pt signals appears ˜1.5 eV (depends on the nature and degree of interaction of Pt with neighbouring elements) higher than that of metallic Pt and assigned to PtO or Pt(OH)₂. The third set of doublets observed at 2.6 eV higher have been reported to be due to the presence of PtO₂.xH₂O or Pt(OH)₄.

Electrochemical Characterization of Pt-M/MWCNT Catalyst

Cyclic Voltammetry of the samples (P-M/MWCNT) both in sulphuric acid and in methanol/sulphuric acid (for methanol oxidation) was carried out. CVs in sulphuric acid provides the background information for the electrochemical processes occurring on the catalyst surfaces such as (i) double layer charging and discharging, (ii) hydrogen adsorption and desorption, hydrogen intercalation, formation of surface oxides (M-Oₓ, M-OₓH_{y}) and the corresponding reduction of these oxides.

Electrochemical Activity of Pt-M Catalyst Before Potential Cycling

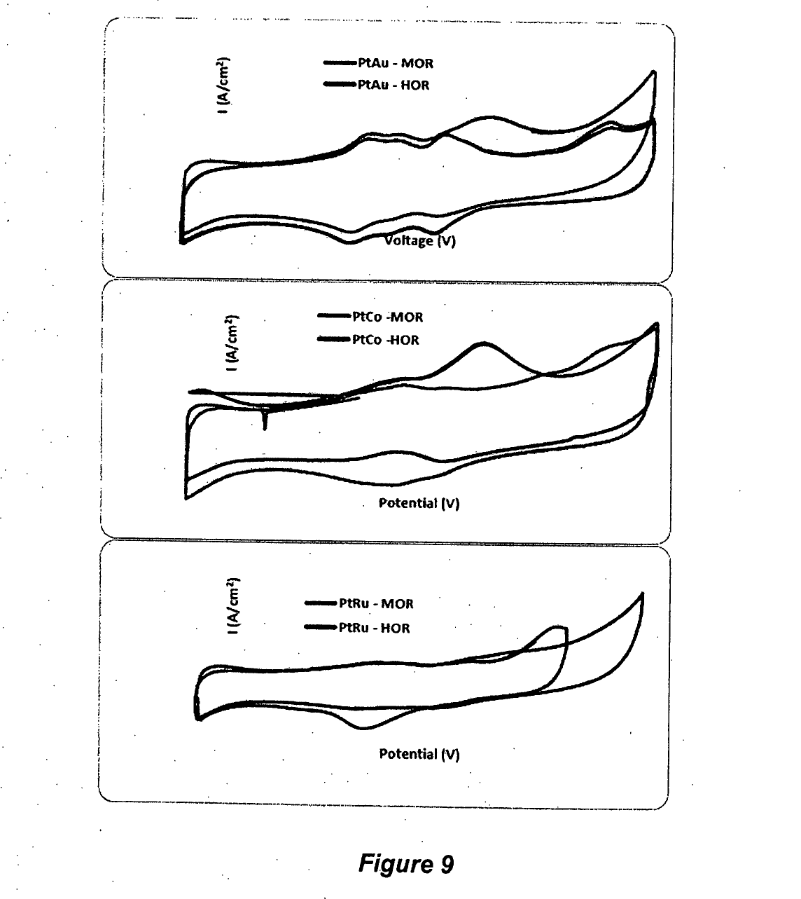

FIG. 9 illustrates the CVs obtained from samples Pt—Co, Pt—Au, Pt—Ru in a solution containing 0.5M sulphuric acid. In comparison to Pt nanoparticles, the alloy nanoparticles show following details and trends (FIG. 9). (1) The addition of Ru or Co or Au as alloy induces more like a Co or Au or Ru response for the bimetallic catalyst than Pt like voltammetric behaviour. (2) For all the bimetallic catalysts the oxide reduction peak corresponding to Pt is shifted to least positive values (from 0.55 to 0.3 V), indicating the presence of surface oxides, in addition to the appearance of anodic current peaks above 0.7 (indicates irreversible reduction of oxides of Co or Au or Ru). The above features relate to atomic mixing of Au or Co or Ru with Pt, with the presence of Co or Ru or Au species in close proximity with surface Pt atoms. (3) Moreover, the reduced charge for hydrogen underpotential desorption (HUD) region of the CV is evident for all bimetallic catalyst in comparison to Pt supported on MWCNT, indicating the reduced availability of electrochemical surface area (ECSA) of Pt atoms at the surface. The CVs of bimetallic catalyst (Pt—Au, Pt—Ru and Pt—Co) for methanol oxidation also show very minimal electrochemical activities (FIG. 9) in comparison to highly active Pt. These observations clearly indicate that Pt surface enrichment is not achieved and so the reaction takes place predominately on Co or Au or Ru atoms (where adsorption of methanol was less likely to take place) present at the surface of a bimetallic catalyst. This screening effect may overcome the expected benefits of any electronic effects induced by alloying Au or Ru or Co with Pt, indicated by XPS.

Electrochemical Activity of Pt-M Catalyst After Potential Cycling

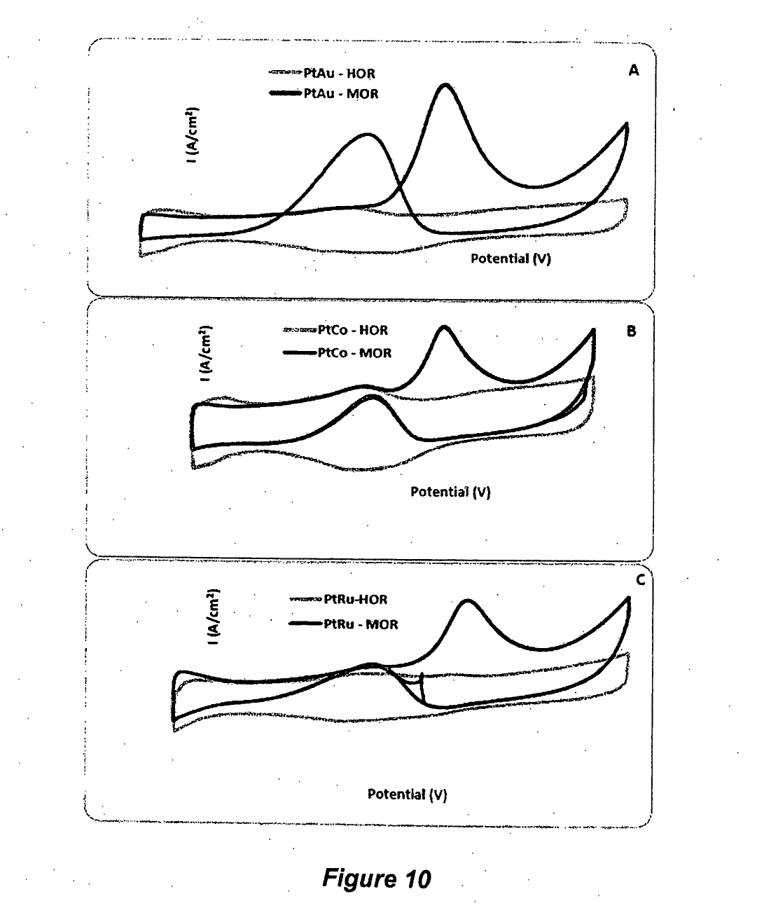

As the Pt surface enrichment on the bimetallic catalyst was not observed by the as synthesised catalytic nanoparticles, they were submitted to repeated potential cycling in 0.5M sulphuric acid solution under oxygen atmosphere, with an aim to dissolve some of the Co or Au or Ru atoms present at the Pt-M alloy particle surface. The cycling was carried out at 50 mv/s in the range of −0.2 to 1 (vs. SCE). After a total of 100 cycles, the observed CV became stable with time, indicating that dissolution of (Co or Au or Ru) from the nanoparticle surface has either ceased or dropped to undetectable levels (regenerated catalyst). FIG. 10 shows the CV curves obtained for bimetallic catalyst in a solution containing 0.5M sulphuric acid and their activity towards methanol oxidation. After cycling, the CV of each of the bimetallic catalysts exhibits an increase in the charge for HUD region of CV, confirming increase in the catalyst surface area, and Pt enrichment in the particle surface, due to dissolution of Co or Au or Ru. So after potential cycling the bimetallic catalyst possesses increased Pt surface area and is composed of a Pt rich shell. The CV curves for methanol oxidation on the regenerated Pt-M/MWCNT catalyst are also shown in FIG. 10. All the regenerated electiocatalysts show significantly enhanced activity towards methanol oxidation after potential cycling. The onset potential (apparent activation energy) for methanol oxidation occurs at about (0.05-0.1) V at the electrodes of all bimetallic catalyst as compared to 0.13 V at Pt/MWCNT. Furthermore, there is a significant shift in the forward anodic peak (I) potential for all bimetallic catalyst as compared to Pt supported on MWCNT. The peak shift towards least positive potential (from 0.66 to 0.55 V vs. SCE) and lower onset potential for methanol oxidation reaction indicates that methanol oxidation occurs more effectively at bimetallic catalyst (at low potential) than at monometallic Pt⁰.

Methanol Oxidation Reaction

Methanol oxidation reaction is a six-electron-transfer reaction, with successive dehydrogenation steps followed by removal of CO. However, during methanol oxidation reaction, pure Pt surface gets poisoned by chemisorbed CO and eventually poisons the catalyst and water hydrolysis reaction (as indicated in reaction 2 in Scheme 1) is very much essential to remove generated CO species from Pt surface. However, in Pt⁰ reaction 2 (in scheme 1) takes place at relatively higher potential of 0.5 V. But for the bimetallic catalyst Pt-M (Ru or Co or Au) the same reaction (reaction 4 in scheme 2) occurs on the surface at considerably low potential (0.2-0.3V), towards the oxidation of generated CO species to CO₂ at low potential. The reason for increased activity on Pt-M is due to the shift in the Pt oxidation peak of all bimetallic catalyst towards low potential (0.2-0.3 V) as compared to Pt (0.5 V), which may facilitate the nucleation of OH species over Ru or Co or Au at much lower potential than at Pt surface (usually 0.5 V).

Scheme 1: Methanol Oxidation on a Pure Pt Surface

Pt+CH₃O_{ads}→Pt(CO)_{ads}+4H⁺+4e⁻ (3)
(In forward reaction (I_{f}) CO gets adsorbed on Pt)

Pt+H₂O→Pt(OH)_{ads}+H⁺+e⁻ (water hydrolysis) (4)

Pt(CO)_{ads}+Pt(OH)_{ads}→CO₂+2H⁺+2e⁻ (5)
(In backward reaction (I_{b}) CO oxidizes to CO₂)

Scheme 2: Methanol Oxidation on Bimetallic Catalyst Pt-M (═Co, Ru, Au) Surface.

Ru+H₂O→Ru(OH)_{ads}+4H⁺+4e⁻ (6)

Pt(CO)_{ads}+Ru(OH)_{ads}→CO₂+2H⁺2e⁻ (7)

The methanol oxidation on Pt and bimetallic catalyst was compared in the following ways to evaluate their catalytic performance: (i) onset potential for methanol anodic peak potential and (ii) ratio of the forward anodic peak current (4) to the reverse anodic peak current (I_{b}). All related data and comparison with the data from references are listed in Table 5.

TABLE 5
Onset Potential, Peak Potential, and If/Ib ratios derived from Pt and
its alloys in 0.5M H₂SO₄ + 0.5M CH₃OH saturated with N2 (E op =
onset potential for CO oxidation; If, I_{b} = forward, backward peak
current during methanol oxidation; R = measure of CO
tolerance of the catalyst).

| Catalyst | Eop (V) | Eat Iₚ (V) | $R = \frac{If}{Ib}$ |
|---|---|---|---|
| Pt | 0.14 | 0.66 | 1.8 |
| PtCo | 0.02 | 0.55 | 4.3 |
| PtAu | 0.05 | 0.55 | 1.4 |
| Pt* | 0.32 | 0.68 | 0.88 |
| PtRu | 0.01 | 0.58 | 6.2 |

*Data obtained from Lima et al., 2009.

The ratio of I_{f}/I_{b} (I_{f} is the forward reaction in which CO gets adsorbed on Pt (reaction 1 in scheme 1); I_{b} is the backward reaction in which CO Oxidizes to CO₂ (reaction 2 in scheme 1) can be used to describe the catalyst tolerance to accumulation of carbonaceous species during oxidation of methanol and is also related to catalyst longevity. From the results present in Table 5, the I_{f}/I_{b} ratio is observed to be very high for PtRu followed by PtCo, Pt and PtAu. The ratio of 6.2 for PtRu bimetallic alloy catalyst is significantly higher than reported for analogous PtRu systems, which indicates the oxidation of carbonaceous species to carbon dioxide in the very forward scan of methanol oxidation. So, the role of Co or Ru or Au atoms is, principally, to promote the increase of activity towards methanol oxidation reaction (water hydrolysis reaction occurs at very low potential), as a result of leaching, which induces enrichment of Pt atoms at the catalyst surface, and the Co or Au or Ru atoms in the inner layer.

Oxygen Reduction Reaction

The kinetics of the ORR on Pt and bimetallic catalyst was evaluated using rotating disk electrode (RDE). FIG. 11 depicts the polarization curves recorded during ORR on Pt and all the bimetallic catalysts at selected rotation rates from 500 to 2000 rpm. All the samples display similar pattern as a function of rotation rate. The curves in FIG. 11A (Pt/MWNT) show three distinct regions: 1) the kinetic region, where the current, Ik, is independent of the rotation velocity, w (between 0.6 and 1); 2) the mixed control region, where the behaviour is determined by kinetic as well as diffusion processes (between 0.4 and 0.6); and 3) the mass transfer region, where the diffusion current, Id, is a function of the rotational velocity (between 0.2 and 0.4). The behaviour of these curves corresponds to analogous catalytic systems exhibiting 4 electron transfer ORR mechanism.

TABLE 6
Kinetic data and onset potential derived from ORR of Pt and
its alloys in 0.5 MH₂SO₄ solution saturated by O₂ (Iₒ =
Exchange current density for ORR; EORR = onset potential for ORR)

| | Iₒ (mA/cm²) × | E_{ORR} | I at 0.8 V × |
|---|---|---|---|
| Catalyst | 10⁻⁶ | onset | 10⁻⁵ |
| Pt | 0.1754 | 0.94 | 0.2634 |
| PtCo | 3.565 | 0.97 | 4.756 |
| PtAu | 7.654 | 0.96 | 8.173 |
| Pt* | 0.0657 | 0.85 | — |
| PtRu | 3.123 | 0.96 | 4.493 |

*Data obtained from Lima et al., 2009.

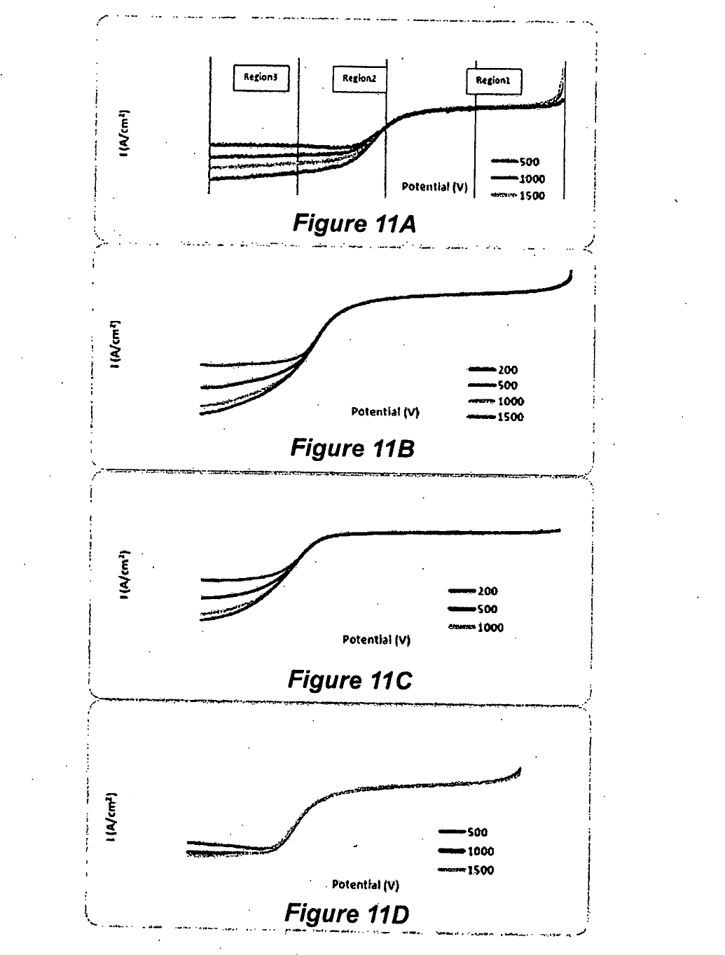

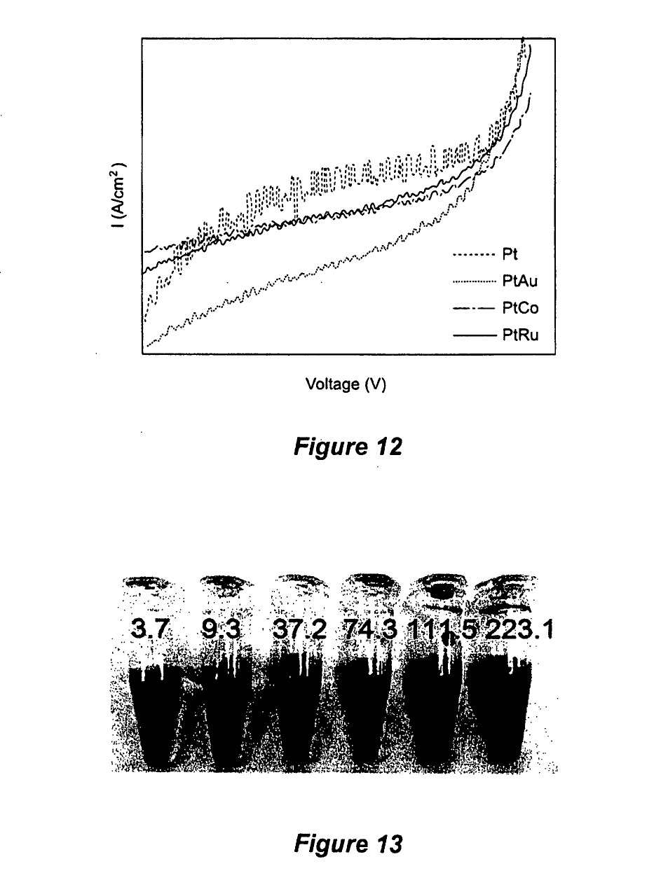

FIG. 12 depicts the performance of Pt and bimetallic catalyst on the ORR recorded at 2000 rpm under the same experimental conditions. The experimental results of the oxygen reduction reaction in the O₂-saturated electrolyte are summarized in Table 6. Clearly, at the fixed potential of 1 V vs RHE, all bimetallic catalysts exhibit unique high activity for ORR. The catalytic improvement of the ORR on these surfaces compared to Pt is approximately a factor of 10 (Table 6). The bimetallic catalysts display better catalytic activity compared to that of Pt in the kinetic and mixed control regions. The performance of bimetallic catalyst PtAu is the best of the series, displaying lower overpotentials in the kinetic region (the region where current density is controlled purely by electrode structure). Also, the onset of ORR on bimetallic catalyst is found at the most positive potential as compared to Pt (Table 6). The higher activity of bimetallic catalyst as compared to Pt towards ORR, seems to arise from higher surface area achieved by dissolution of Co or Au or Ru atoms. Apart from surface area underlying factors like lattice mismatch, Pt—Pt bond contraction and ligand, caused by strong interaction between Pt and Co or Au or Ru atoms effect, would also have contributed to higher activity of bimetallic catalyst. The above mentioned factors are found to influence the chemisorption/adsorption of simple molecules like H₂, O₂ and CO significantly and accounts for the increasing amount of Pt sites for the adsorption of O₂ in the kinetic region for bimetallic catalyst. It is concluded from the studies that alloying of Co or Au or Ru induces the formation of surface active Pt at shell and Pt—Co or Au or Ru as core, achieved through potential cycling. These potential cycled catalysts show high activity towards methanol oxidation reaction by forming Ru or Co or Au oxides at very low potential, necessary for oxidation of CO to CO₂. The same catalyst when tested towards ORR shows high activity exclusively in high potential region, usually Pt suffers from high overpotential loss.

### Example 6

### Preparation of Rec1-Resilin Stabilized Ag Nanoparticles

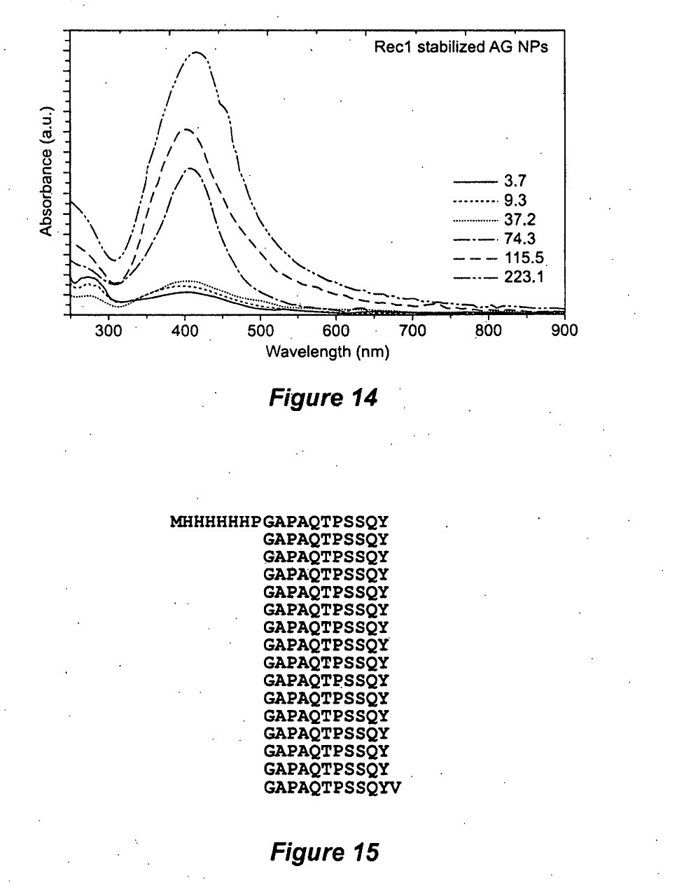

An aqueous solution of rec1-resilin was prepared, with controlled pH. To the solution of rec1-resilin an aqueous solution of a silver precursor, such as AgNO₃, was added and the mixture was sonicated to achieve uniform mixing. Excess sodium borohydride (2.5 times molarity of metallic precursor) was then added and this resulted in silver nanoparticle formation which was observed optically (colour change) (FIG. 13). Spectroscopic (UV-Vis spectroscopy) analysis (FIG. 14) confirmed the presence of silver nanoparticles. The experiments were performed as a function of metal precursor concentration (fixed protein concentration; with different Metal/protein molar ratio) (Table 7). All of the samples changed colour instantly after the addition of NaBH₄. The colour observed was yellow/green, with the samples with less rec1-resilin and a higher content of nanoparticle showing a deeper yellow/brown colour which then lightened and became more yellow/green with increasing protein concentration. The size distribution of the generated nanoparticles related to the metal plasmon peak position and the expected Metal/Protein (287 nm) plasmon peak ratio increased with increasing metal precursor concentration.. The position of the peaks in the UV-vis Spectra shifted from 422 nm to 407 nm. This indicates that the size of the silver nanoparticles decreased as the protein concentration increased. The higher availability of protein resulted in smaller stabilized silver nanoparticles.

TABLE 7
Rec1-resilin stabilized silver nanoparticles
(Materials: Rec1, PBS, NaOH, AgNO₃, NaBH_{4;} Sequence:
PBS + NaOH + Rec1 + AgNO₃ + NaBH₄)

| Sample | Protein | Metal/Rec1 | Ag Plasmon | Ag/Rec1 Plasmon |
|---|---|---|---|---|
| name | Conc. | molar ratio | peak | peak ratio |
| RS1 | High | 3.7 | 411 | 0.62 |
| RS2 | ↓ | 9.3 | 407 | 0.95 |
| RS3 | Low | 37.2 | 409 | 1.89 |
| RS4 | | 74.3 | 414 | 3.28 |
| RS5 | | 111.5 | 408 | 3.12 |
| RS6 | | 223.1 | 422 | 2.92 |

### Example 7

### Preparation of Resilin Mimetic Protein An16 Stabilized Gold Nanoparticles

Template directed formation and stabilization of noble metal nanoparticles was demonstrated with An16, a resilin mimetic biomimetic protein. Lyons et al. (Lyons et al. 2007) have reported a recursive cloning strategy for generating synthetic genes encoding multiple copies of consensus polypeptides based on the repetitive domains within resilin-like genes from the mosquito Anopheles gambiae. The resulting resilin-mimetic protein known as An16 represents a periodic polypeptide consisting of 16 copies of an 11-residue repeat sequence: GAPAQTPSSQY (FIG. 15). It has 185 amino acid residues. An16 also exhibits outstanding resilience (>90%) with distinct advantages of shorter repeat sequences, lower structural complexity, and greater expression yields over rec1-resilin.

An aqueous solution of An16 was prepared with controlled pH. To the solution of An16 an aqueous solution of a gold precursor, such as HAuCl₄, was added and the mixture was sonicated to achieve uniform mixing. Excess sodium borohydride (2.5 times molarity of metallic precursor) was then added and gold nanoparticle formation was observed. The An16 concentration was varied to alter the metal to protein molar ratio from 5.7 to 228.6 as shown in the following table (Table 8).

TABLE 8
An16- stabilized Au nanoparticles (Materials:
An16, PBS, NaOH, HAuCl₄, NaBH_{4;} Sequence:
PBS + NaOH + An16 + HAuCl₄ + NaBH₄)

| Sample | Protein | Metal/An16 | Au Plasmon | Au/An16 Plasmon |
|---|---|---|---|---|
| name | Conc. | molar ratio | peak | peak ratio |
| RG1 | High | 5.7 | 523 | 0.10 |
| RG2 | ↓ | 9.5 | 523 | 0.17 |
| RG3 | Low | 28.6 | 517 | 0.41 |
| RG4 | | 85.7 | 528 | 0.80 |
| RG5 | | 143.1 | 528 | 0.88 |
| RG6 | | 228.6 | 531 | 0.93 |

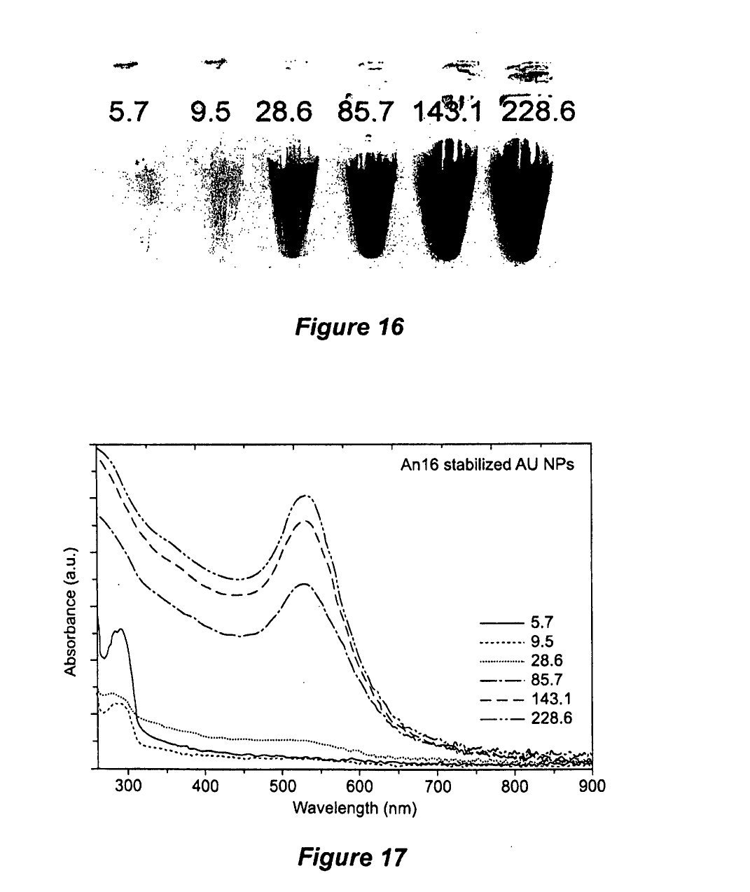

All of the samples changed colour instantly after the addition of NaBH₄. The colour observed was red, with the samples with less An16 protein showing a deeper red colour which then lightened with increasing protein concentration (FIG. 16). The position of the peaks in the UV-vis spectra shifted from 531 nm to 517 nm (FIG. 17) which confirmed the presence of gold nanoparticles. The solution was found to be stable for many months.

### Example 8

### Preparation of Resilin Mimetic Protein An16 Stabilized Silver Nanoparticles

An-16 stabilized Ag nanoparticles were formed using the procedure provided in Example 7 but replacing HAuCl₄ with AgNO₃. The An16 concentration was varied to alter the metal to protein molar ratio from 3.7 to 223.1 as shown in the following table (Table 9).

TABLE 9
An16- stabilized Ag nanoparticles (Materials:
An16, PBS, NaOH, AgNO₃, NaBH₄; Sequence:
PBS + NaOH + An16 + AgNO₃ + NaBH₄)

| | | | Ag Plasmon | |
|---|---|---|---|---|
| Sample | Protein | Metal/An16 | peak-From | Ag/An16 Plasmon |
| name | Conc. | molar ratio | Uv-Vis | peak ratio |
| RG1 | High | 3.7 | 403 | 0.49 |
| RG2 | ↓ | 9.3 | 405 | 1.01 |
| RG3 | Low | 37.2 | 400 | 2.26 |
| RG4 | | 74.3 | 416 | 2.49 |
| RG5 | | 111.5 | 423 | 2.86 |
| RG6 | | 223.1 | 423 | 2.93 |

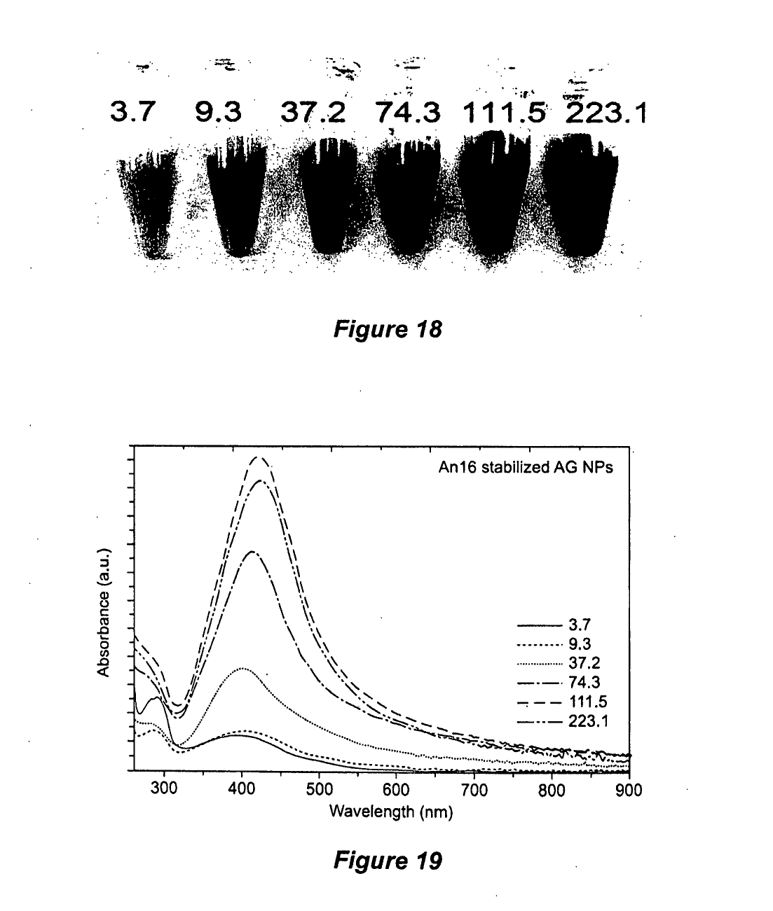

All of the samples changed colour instantly after the addition of NaBH₄. The colour observed was yellow, with the samples with less An16 protein showing a yellow/brown colour which then lightened with increasing protein concentration (FIG. 18). The position of the peaks in the UV-vis spectra shifted from 423 nm to 400 nm (FIG. 19) which confirmed the presence of silver nanoparticles.

### Example 9

### Preparation of Au Nanoparticles Stabilized with Bombyx mori Silk Fibroin

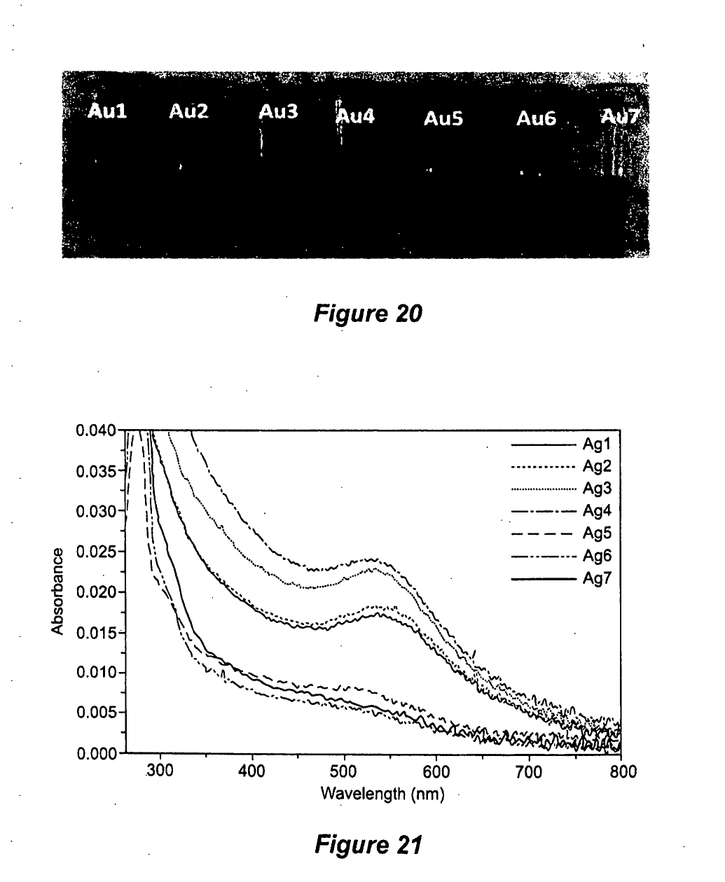

An aqueous solution of silk fibroin (2 wt %) was prepared using the method described in Rockwood et al (2011). An aqueous solution of a gold precursor (HAuCl₄) was added to the aqueous silk solution and the mixture was sonicated to achieve uniform mixing. The silk fibroin concentration was varied to alter the metal to protein molar ratio from 9 to 219 as shown in the following table (Table 10). NaBH₄ was added to the reaction mixture to reduce the metal particles and initiate the gold nanoparticle formation. The molar ratio of NaBH₄ to HAuCl₄ was maintained at 2.5:1 for all of the samples. Upon addition of NaBH₄ an instant colour change was detected (FIG. 20). UV-vis spectrometry was used to confirm gold particle formation and the particle size of the gold nanoparticles stabilized by the silk fibroin particles (FIG. 21).

TABLE 10
Silk fibroin-stabilized Au nanoparticles

| Sample | Au:Silk fibroin protein | |
|---|---|---|
| ID | molar ratio (M/P) | Plasmon peak |
| Au1 | 219 | 536 |
| Au2 | 146 | 536 |
| Au3 | 109 | 536 |
| Au4 | 55 | 530 |
| Au5 | 27 | 500 |
| Au6 | 18 | 500 |
| Au7 | 9 | 498 |

All of the samples changed colour instantly after the addition of NaBH₄. The colour observed was red, with the samples with less silk fibroin protein showing a deeper red colour which then lightened with increasing protein concentration (FIG. 20). The position of the peaks in the UV-vis spectra shifted from 536 nm to 498 nm (FIG. 21) with an increase in the protein concentration. This indicates that the size of the gold nanoparticles decreased as the protein concentration increased. The higher availability of protein resulted in smaller stabilized gold nanoparticles.

### Example 10

### Preparation of Ag Nanoparticles Stabilized with Bombyx mori Silk Fibroin

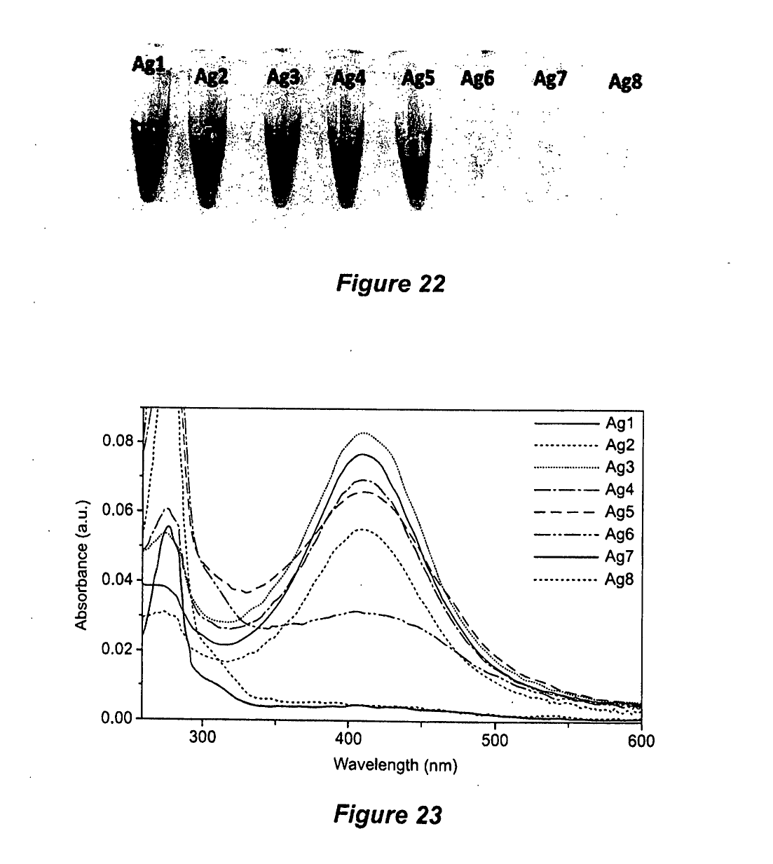

An aqueous silk fibroin was prepared as described in Example 9. An aqueous solution of silver precursor (AgNO₃) was added to the silk solution and the mixture was sonicated to achieve uniform mixing. The silk fibroin concentration in the solution was varied to alter the metal to protein molar ratio from 4 to 219 (Table 11). NaBH₄ was added to the reaction mixture to reduce the metal particles and initiate the silver nanoparticle formation. The molar ratio of NaBH₄ to AgNO₃ was maintained at 2.5:1 for all of the samples. Upon addition of NaBH₄ an instant colour change was detected (FIG. 22) and then UV-vis spectrometry (FIG. 23) was used to give an indication of the particle size of the silver nanoparticles stabilized by the silk fibroin particles.

TABLE 11
Silk fibroin-stabilized Ag nanoparticles

| Sample | Ag:Silk fibroin protein | |
|---|---|---|
| ID | molar ratio (M/P) | Plasmon peak |
| Ag1 | 219 | 411 |
| Ag2 | 146 | 411 |
| Ag3 | 109 | 410 |
| Ag4 | 55 | 411 |
| Ag5 | 27 | 410 |
| Ag6 | 18 | 414 |
| Ag7 | 9 | 405 |
| Ag8 | 4 | 404 |

All of the samples changed colour instantly after the addition of NaBH₄. The colour observed was yellow/green, with the samples with less silk fibroin protein showing a deeper yellow colour which then lightened and became more yellow/green with increasing protein concentration (FIG. 22). The position of the peaks in the UV-vis spectra shifted from 414 nm to 404 nm with an increase in the protein concentration. This indicates that the size of the silver nanoparticles decreased as the protein concentration increased. The higher availability of protein resulted in smaller stabilized silver nanoparticles.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

### REFERENCES

S. Alayoglu, A. U. Nilekar, M. Mavrikakis, B. Eichhorn, Nat. Mater., 2008, 7, 333.

A. S. Aricò, A. K. Shukla, H. Kim, S. Park, M. Min, V. Antonucci, App. Sur. Sci., 2001, 172, 33.

L. D'Souza, and R. Richards, in ‘Catalyst Preparation: Science and Engineering, ed. J. Regalbuto, CRC Press, Boca Raton, 2007, 93.

N. K. Dutta, M. Y. Truong, S. Mayavan, N. R. Choudhury, C. M. Elvin, M. Kim, R. Knott, K. M. Nairn, A. J. Hill, Angew. Chem. Int. Ed., 2011, 50, 4428.

C. M. Elvin, A. G. Carr, M. G. Huson, J. M. Maxwell, R. D. Pearson, T. Vuocolol, N. E. Liyoul, D. C. C. Won, D, J,. Merritt, N. E. Dixon, Nature, 2005, 437, 999.

U. Heiz, A. Sanchez, S. Abbet, W. D. Schneider, J. Am. Chem. Soc., 1991, 121, 32147.

C.-T Hsieh, J-Yi Lin, J. Power Sources, 2009, 188, 347.

S. H. Joo, J. Y. Park, C. K. Tsung, Y. Yamada, P. D. Yang, G. A. Somorjai, Nat. Mater., 2009, 8, 126.

K. C. Lee, B. Park, Y. Park, B. L. Jaeseung, K. Hasuck, Appl. Phys. Lett., 2007, 91, 113101.

I. Lisiecki, J. Phys. Chem. B., 2005, 109, 12231.

F. H. B. Lima, J. F. R. de Castro, L. G. Santos, E. A. Ticianelli, J. Power Sources, 2009, 190, 293.

Z. Liu, X. Y. Ling, X. Su, J. Y. Lee, J. Phy. Chem. B., 2004, 108, 8234.

R. E. Lyons, E. Lesieur, M. Kim, D. C. Wong, M. G. Huson, K. M. Nairn, A. G. Brownlee, R. D. Pearson, C. M. Elvin, Protein Eng Des Sel. 2007, 20, 25.

K. Mette, A. Bergmann, J-P. Tessonnier, M. Havecker, L. Yao, T. Ressler, R. Schlögl, P. Strasser, M. Behrens, Chem. Cat. Chem., 2012, 4, 851.

I. Meusel, J. Hoffmann, J. Hartmann, J. Libuda, H.-J. Freud, J. Phys. Chem. B., 2001, 105, 3567.

M. P. Pileni, Nat Mater, 2003, 2, 11145.

J. Prabhuram et al., J. Phys. Chem B., 2006, 110, 5245.

R. Richards, R. Mörtel, H. Bönnemann, Fuel Cells Bull., 2001, 4, 7.

D N Rockwood, R C Preda, T Yücel, X Wang, M L Lovett & D L Kaplan, Nature protocols, 2011, 6, 1612.

M. Schrinner, Science, 2009, 323, 617.

Y. Shao, G. Yin, J. Wang, Y. Gao, P. Shi, J. Power Sources, 2006, 161, 47.

R. Shenhar, T. B Norsten, V. M Rotello, Adv. Mater., 2005, 17, 657.

S. Si, R. R. Bhattacharjee, A. Banarjee, T. Mandal, Chem. Eur. J., 2006, 12, 1256.

V. R. Stamenkovic, B. Fowler, B Simon Mun, G Wang, P N. Ross, C A. Lucas, N M. Markovi, Science, 2007, 315, 493.

W. Tang, S. Jayaraman, T. F. Jaramillo, G. D. Stucky, E. W. McFarland, J. Phys. Chem. C., 2009, 113, 5014.

A. S. Tatham, P. R. Shewry, Phil. Trans. R. Soc. Lond. B, 2002, 357, 229.

M. Y., Truong, N. K. Dutta, N. R. Choudhury, M. Kim, C. M. Elvin, A. J. Hill, B. Thierry, K. Vasilev, Biomaterials 2010, 31, 4434.

L. Wang, G. Wei, L Sun, Z. Liu, Y. Song, T. Yang, Y. Sun, C. Guo, Z. Li, Nanotechnology, 2006, 17, 2907.

S. C. Warren, L. C. Messina, L. S. Slaughter, M. Kamperman, Q. Zhou, S. M. Gruner, F. J. DiSalvo, U. Wiesner, Science, 2008, 320, 1748.

J. Zhang, K. Sasaki, E. Sutter, R. R. Adzic, Science, 2007, 315, 220.

1. A composition of matter comprising metal nanoparticles dispersed in a protein matrix comprising an elastic protein or homolog or fragment thereof.

2. The composition of claim 1, wherein the metal is a noble metal.

3. (canceled)

4. The composition of claim 2, wherein the noble metal is selected from the group consisting of: platinum, gold, and silver.

5. The composition of claim 1, wherein the elastic protein is selected from the group consisting of resilin, silk proteins, elastin, titin, fibrillin, lamprin, gliadin, abductin, byssus, spectrin, and homologs or fragments of any of the aforementioned.

6. (canceled)

7. The composition of claim 5, wherein the elastic protein or homolog or fragment thereof is rec-1 resilin or a homolog thereof.

8. The composition of claim 7, wherein the elastic protein or homolog or fragment thereof is An 16-resilin or a homolog thereof.

9. The composition of claim 8, wherein the elastic protein or homolog or fragment thereof is silk fibroin.

10. The composition of claim 9, wherein the silk fibroin is Bombyx mori silk fibroin.

11. The composition of claim 10, wherein the metal is an electrocatalyst metal.

12. The composition of claim 11, wherein the electrocatalyst metal is selected from the group consisting of platinum, palladium, gold, silver, manganese, iron, magnesium, and compounds or alloys of any one or more of the aforementioned metals.

13. The composition of claim 12, wherein the electrocatalyst metal is platinum and/or a platinum alloy.

14. The composition of claim 13, wherein the electrocatalyst metal is a platinum alloy selected from the group consisting of: Pt/Ru, Pt/Co, Pt/Fe, Pt/Ni, Pt/Mn, Pt/Ti, Pt/Cr, Pt/Cu, Pt/Pd, Pt/Rh, Pt/Ir, Pt/Ag, and Pt/Au.

15. The composition of claim 11, wherein the electrocatalyst metal is palladium met-a4 and/or a palladium alloy.

16. The composition of claim 15, wherein the electrocatalyst metal is a palladium alloy selected from the group consisting of: Pd/Co, Pd/Ni, Pd/Au, Pd/Ru, Pd/Ir, Pd/Mn, Pd/Ti, Pd/Cr, Pd/Cu, Pd/Ag and Pd/Rh.

17. The composition of claim 11, wherein the electrocatalyst metal is manganese or a compound or alloy thereof.

18. An electrocatalyst comprising the composition of claim 1.

19. An electrode comprising an electrically conductive support and the composition of claim 9 on the support.

20. (canceled)

21. (canceled)

22. An electrochemical half-cell comprising an electrode of claim 19 and a housing for maintaining an electrolyte in contact with the electrode.

23. A fuel cell comprising an electrolyte membrane and an anode and a cathode sandwiching the electrolyte membrane, at least one of the cathode and anode comprising an electrode of claim 19.

24. A method of preparing nanoparticles of a metal, the method comprising reducing ions of the metal in the presence of an elastic protein or homolog or fragment thereof to provide zerovalent metal nanoparticles dispersed in a protein matrix comprising the elastic protein or homolog or fragment thereof.

25. (canceled)

26. (canceled)
